(19) United States
(12) Patent Application Publication
(10) Pub. No.: US 2018/0005163 A1
(43) Pub. Date: Jan. 4, 2018

(54) System and Method for Connecting a User and an Employment Resource

(71) Applicants: Deborah Ramo, Santa Monica, CA (US); Nicole Howson, Provo, UT (US)

(72) Inventors: Deborah Ramo, Santa Monica, CA (US); Nicole Howson, Provo, UT (US)

(73) Assignee: Amavitae Corporation, Santa Monica, CA (US)

(21) Appl. No.: 15/536,133

(22) PCT Filed: Mar. 9, 2016
(86) PCT No.: PCT/US2016/021599

§ 371 Date: Jun. 15, 2017

Related U.S. Application Data
(60) Provisional application No. 62/130,534, filed on Mar. 9, 2015.

(51) Int. Cl. G06Q 10/06; G06Q 10/10; A63F 13/85; G09B 7/077; A63F 13/798

(52) U.S. Cl. CPC G06Q 10/063112; G09B 7/077; A63F 13/798; A63F 13/85; G06Q 10/1053

(57) ABSTRACT

A system for connecting a user to an employment resource tailored to the user includes: a computational device configured to assess the user, using an assessment questionnaire, regarding one or more of an interest, a hard skill, a soft skill, a job-specific skill, an occupational personality trait, training, education, experience, and aptitude for a job. A method for connecting a user to an employment resource tailored to the user includes: assessing, by a computational device, using an assessment questionnaire, the user regarding one or more of an interest, a hard skill, a soft skill, a job-specific skill, an occupational personality trait, training, education, experience, and aptitude for a job; and presenting, by the computational device, the assessment to one or more of the user and a prospective employer of the user.

### PRIORITY CLAIM

The present application claims the priority benefit of U.S. provisional patent application No. 62/130,534 filed Mar. 9, 2015 and entitled “System and Method for Connecting a Job Candidate, an Employer, and an Employment Resource,” the disclosure of which is incorporated herein by reference.

### SUMMARY

Embodiments of the invention relate in general to a system and method for connecting a user to an employment resource tailored to the user.

A system for connecting a user to an employment resource tailored to the user includes: a computational device configured to assess the user, using an assessment questionnaire, regarding one or more of an interest, a hard skill, a soft skill, a job-specific skill, an occupational personality trait, training, education, experience, and aptitude for a job.

A system for connecting a user to an employment resource tailored to the user includes: a computational device configured to present a game to the user to play, the computational device configured to score the user based on the user's play, regarding one or more of an interest, a hard skill, a soft skill, a job-specific skill, an occupational personality trait, training, education, experience, and aptitude for a job, the computational device further configured to ask a high-scoring user for permission to share the high-scoring user's score with a prospective employer of the high-scoring user, the computational device further configured to present the high-scoring user's score to the prospective employer.

A method for connecting a user to an employment resource tailored to the user includes: assessing, by a computational device, using an assessment questionnaire, the user regarding one or more of an interest, a hard skill, a soft skill, a job-specific skill, an occupational personality trait, training, education, experience, and aptitude for a job; and presenting, by the computational device, the assessment to one or more of the user and a prospective employer of the user.

A method for connecting a user to an employment resource tailored to the user includes: using a computational device configured to present a game to the user to play, presenting a game to a user to play; scoring the user, by the computational device, based on the user's play, regarding one or more of an interest, a hard skill, a soft skill, a job-specific skill, an occupational personality trait, training, education, experience, and aptitude for a job; asking a high-scoring user for permission to share the high-scoring user's score with a prospective employer of the high-scoring user; and presenting, by the computational device, the high-scoring user's score to the prospective employer.

### DESCRIPTION OF THE DRAWINGS

FIG. 1 is a site map of principal components of a system and method for connecting a user to an employment resource tailored to the user.

FIGS. 2-17 are a series of screenshots of a system and method for connecting a user to an employment resource tailored to the user, using an assessment on a computational device.

FIGS. 18-31 are a series of screenshots of a system and method for connecting a user to an employment resource tailored to the user, using an assessment questionnaire on a computational device.

FIGS. 32-45 are a series of screenshots of a system and method for connecting a user to an employment resource tailored to the user, using a game played on a computational device.

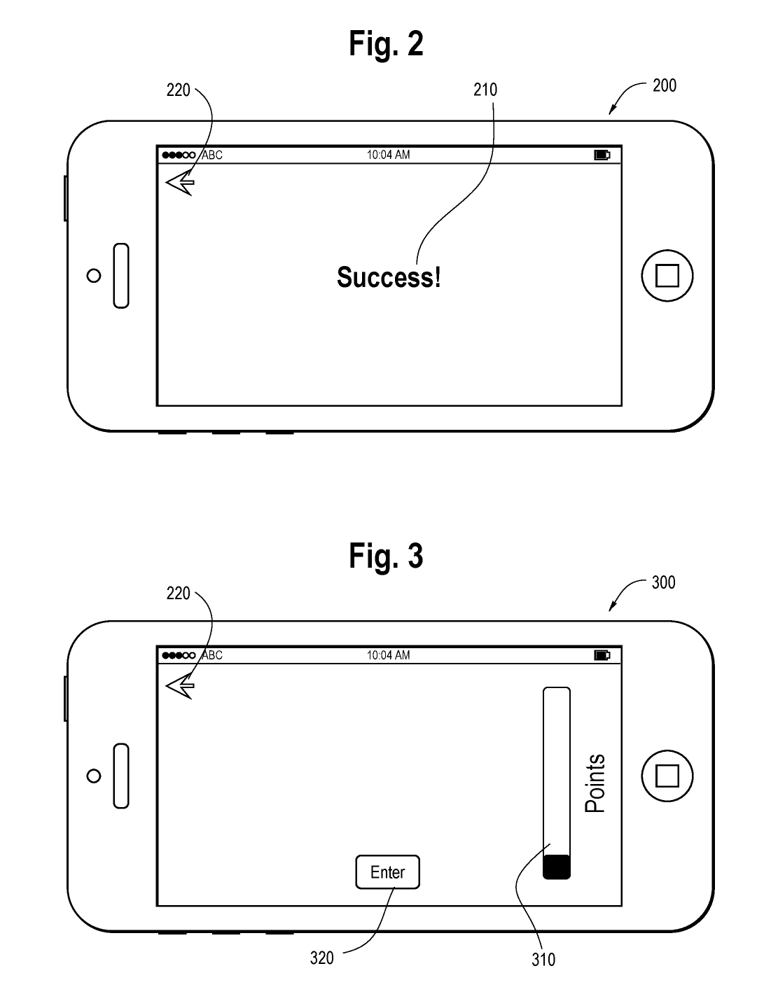

FIG. 2 is a screenshot of a success screen shown to a user in a system and method for connecting a user to an employment resource tailored to the user, using a game played on a computational device.

FIG. 3 is a screenshot of a welcome screen in a system and method for connecting a user to an employment resource tailored to the user, using a game played on a computational device.

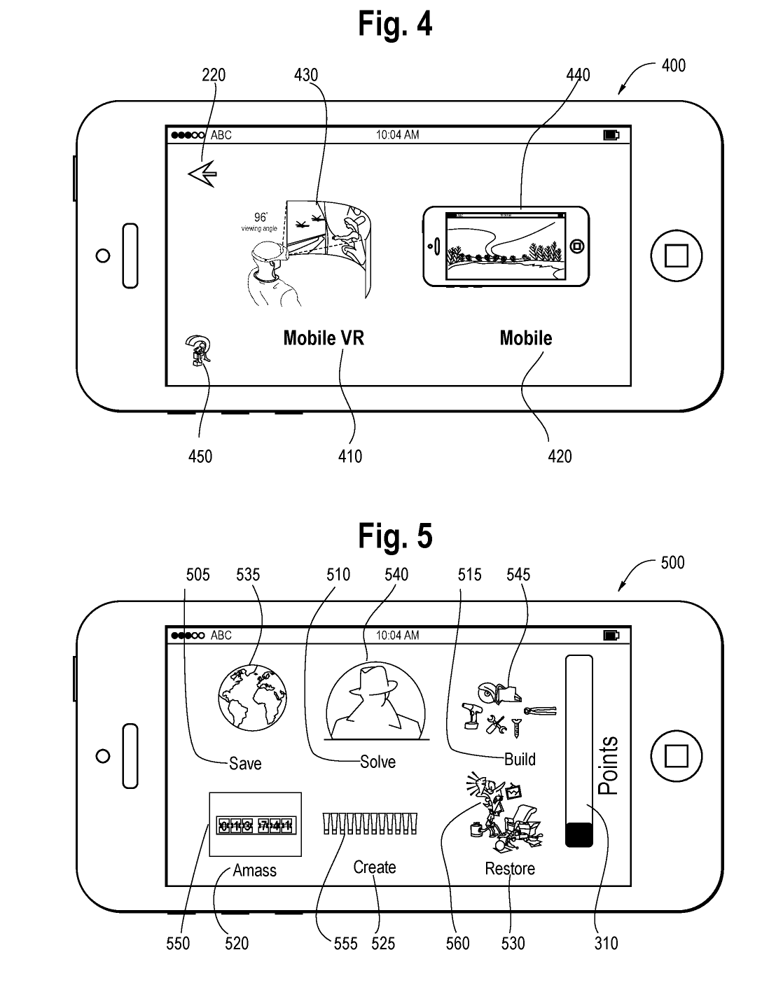

FIG. 4 is a screenshot of an optional format selection screen in a system and method for connecting a user to an employment resource tailored to the user, using a game played on a computational device.

FIG. 5 is a screenshot of a first game selection screen in a system and method for connecting a user to an employment resource tailored to the user, using a game played on a computational device.

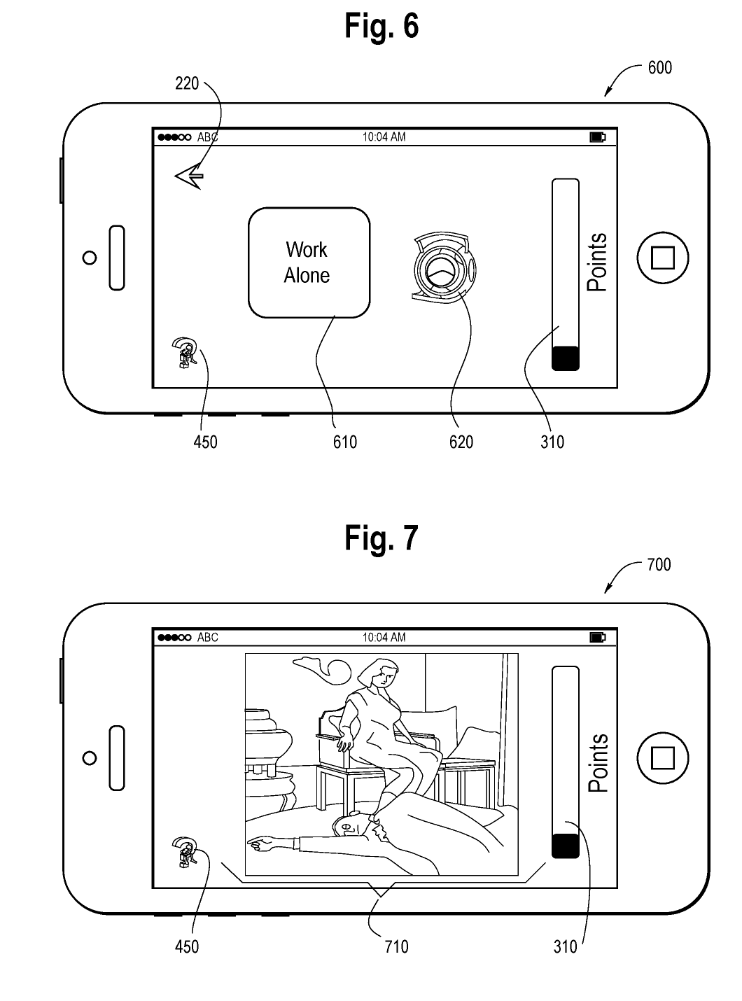

FIG. 6 is a screenshot of a game play start screen in a system and method for connecting a user to an employment resource tailored to the user, using a game played on a computational device.

FIG. 7 is a screenshot of a “solve a mystery” screen in a system and method for connecting a user to an employment resource tailored to the user, using a game played on a computational device.

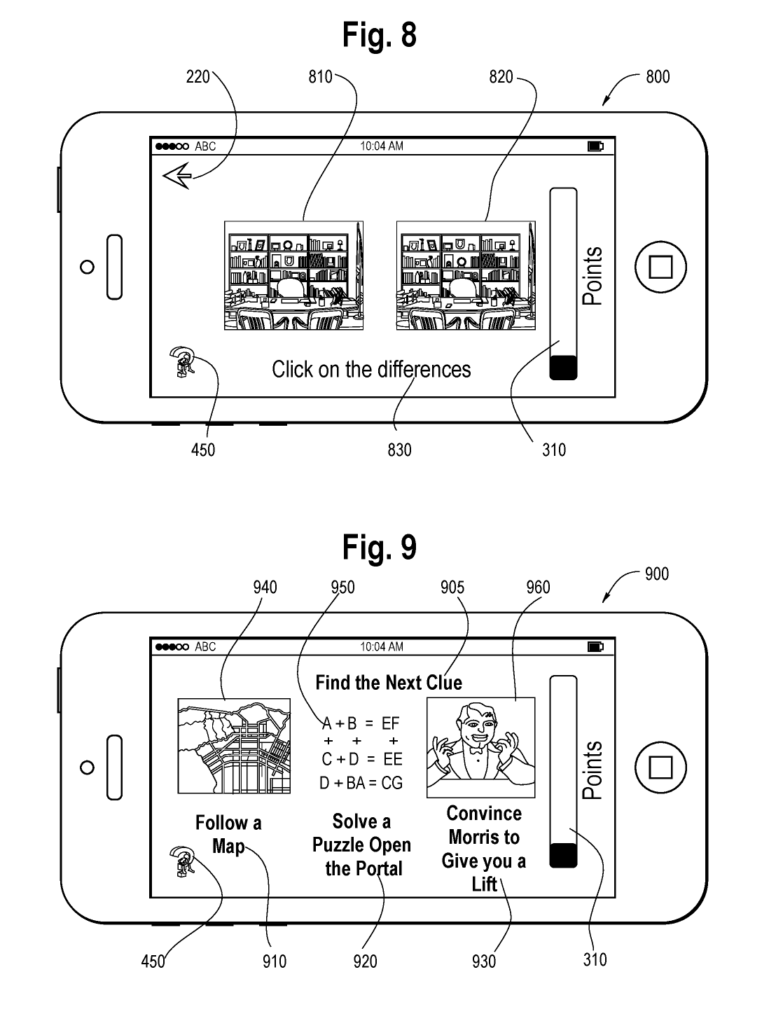

FIG. 8 is a screenshot of a first game screen in a system and method for connecting a user to an employment resource tailored to the user, using a game played on a computational device.

FIG. 9 is a screenshot of a game mechanics selection screen in a system and method for connecting a user to an employment resource tailored to the user, using a game played on a computational device.

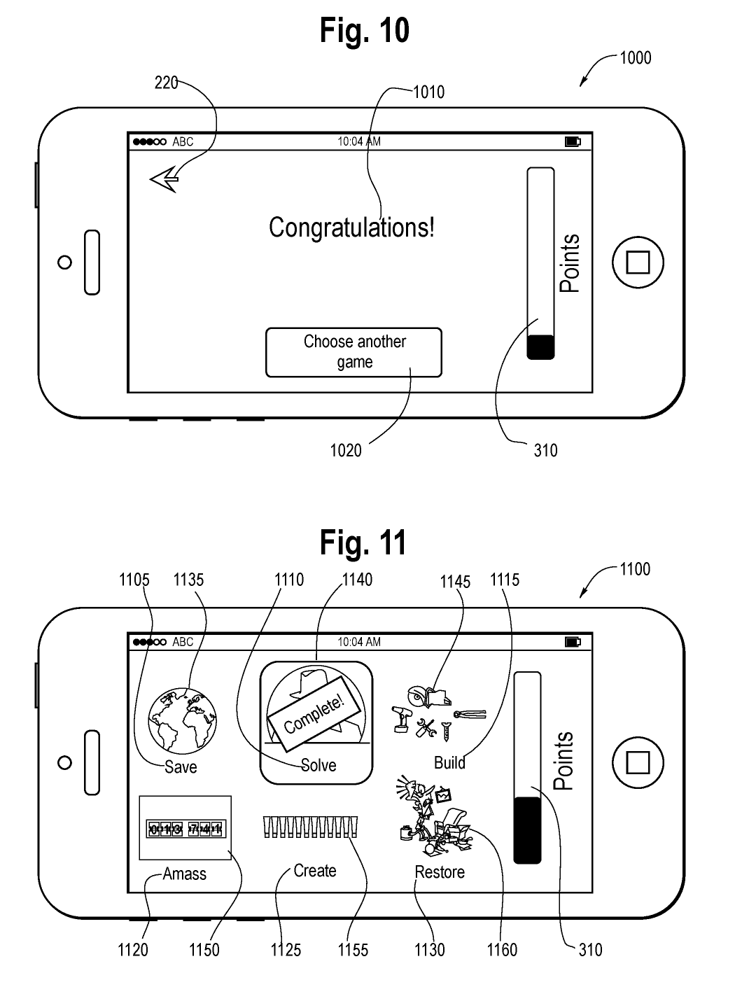

FIG. 10 is a screenshot of a first game completion screen in a system and method for connecting a user to an employment resource tailored to the user, using a game played on a computational device.

FIG. 11 is a screenshot of a second game selection screen in a system and method for connecting a user to an employment resource tailored to the user, using a game played on a computational device.

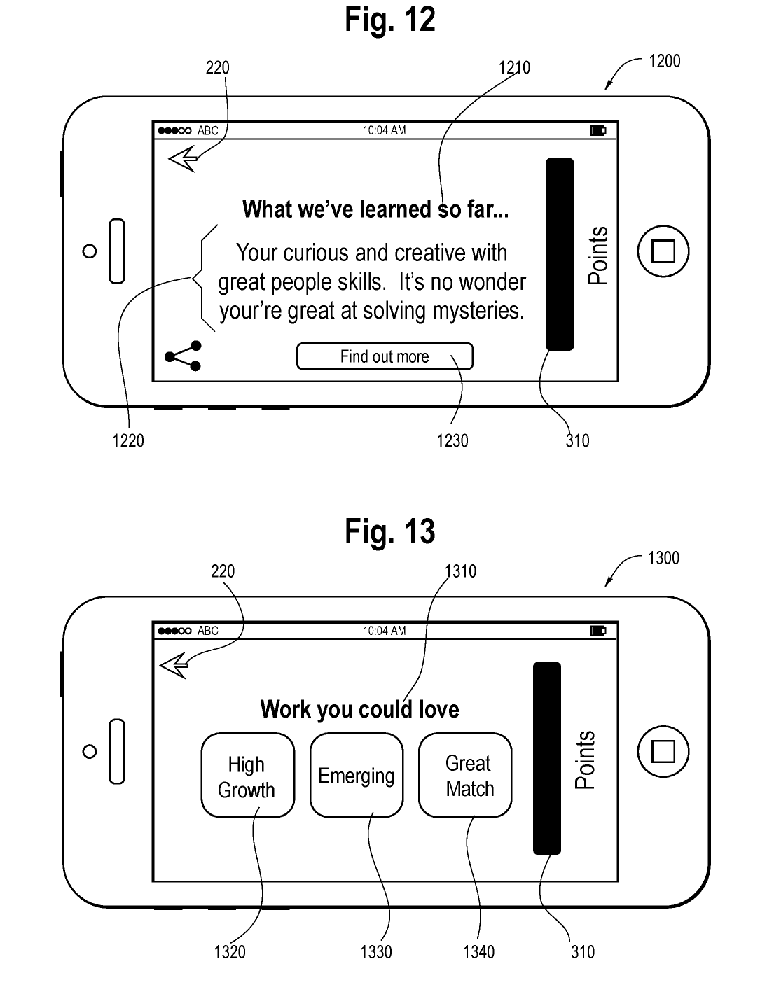

FIG. 12 is a screenshot of a summary screen in a system and method for connecting a user to an employment resource tailored to the user, using a game played on a computational device.

FIG. 13 is a screenshot of a job category suggestion screen in a system and method for connecting a user to an employment resource tailored to the user, using a game played on a computational device.

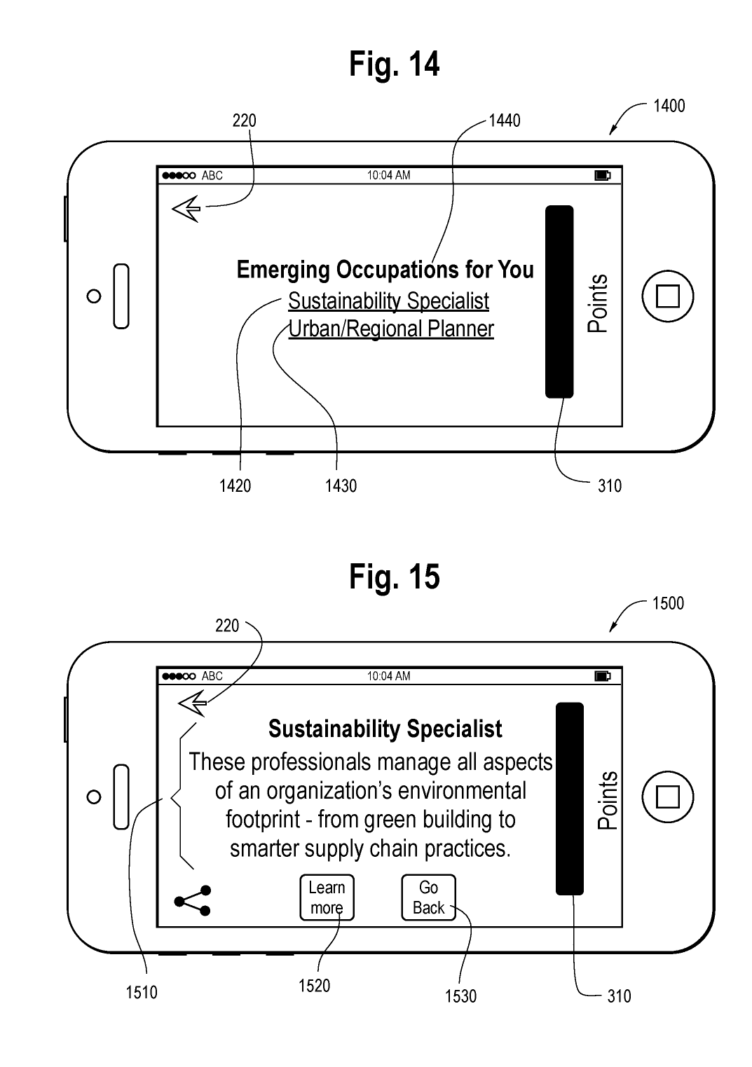

FIG. 14 is a screenshot of an emerging jobs screen in a system and method for connecting a user to an employment resource tailored to the user, using a game played on a computational device.

FIG. 15 is a screenshot of a selected job screen in a system and method for connecting a user to an employment resource tailored to the user, using a game played on a computational device.

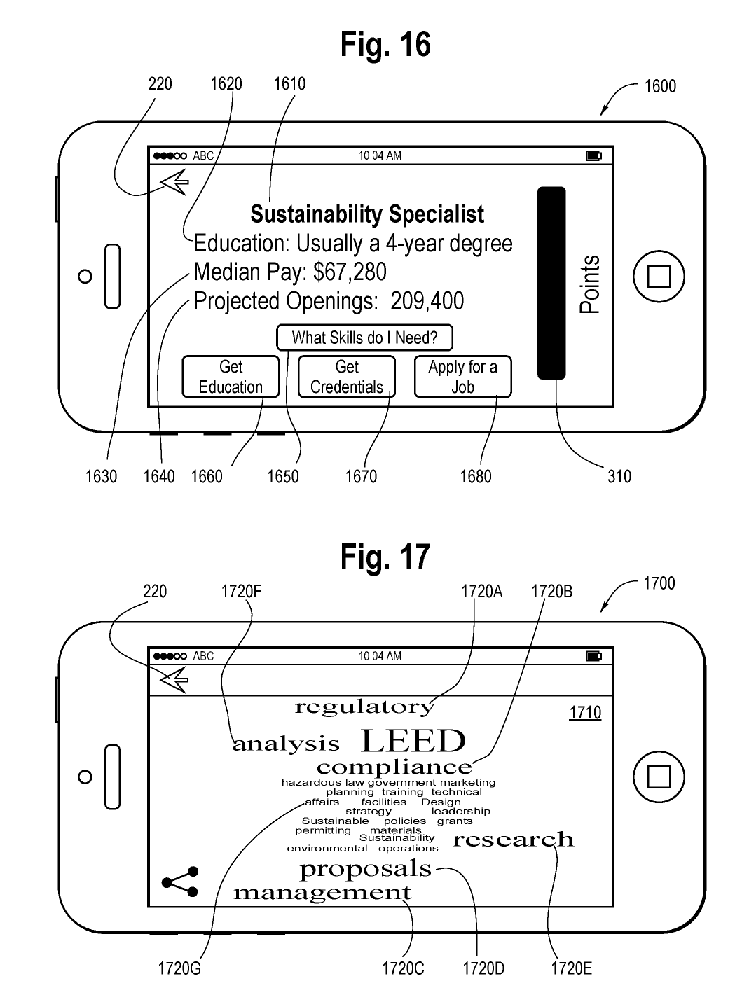

FIG. 16 is a screenshot of a selected job details screen in a system and method for connecting a user to an employment resource tailored to the user, using a game played on a computational device.

FIG. 17 is a screenshot of a selected job skills screen in a system and method for connecting a user to an employment resource tailored to the user, using a game played on a computational device.

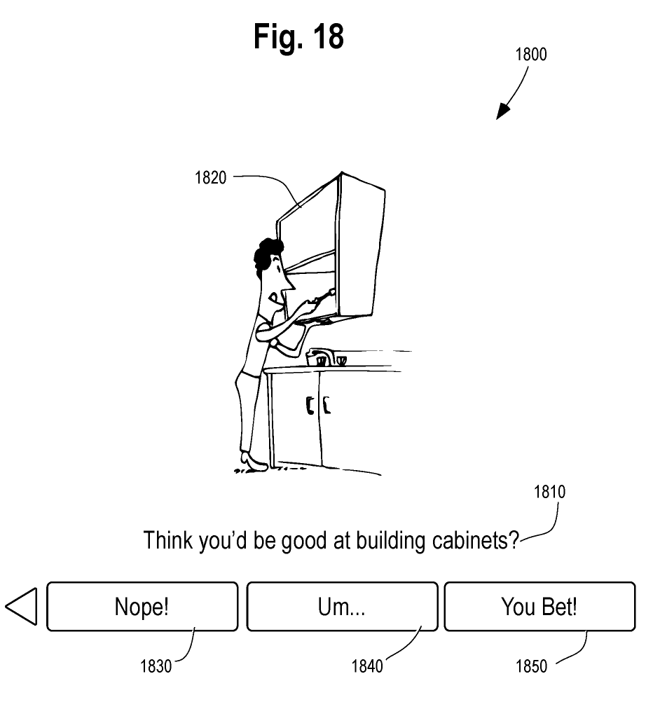

FIG. 18 is a screenshot of a first assessment question screen in a system and method for connecting a user to an employment resource tailored to the user, using an assessment questionnaire on a computational device.

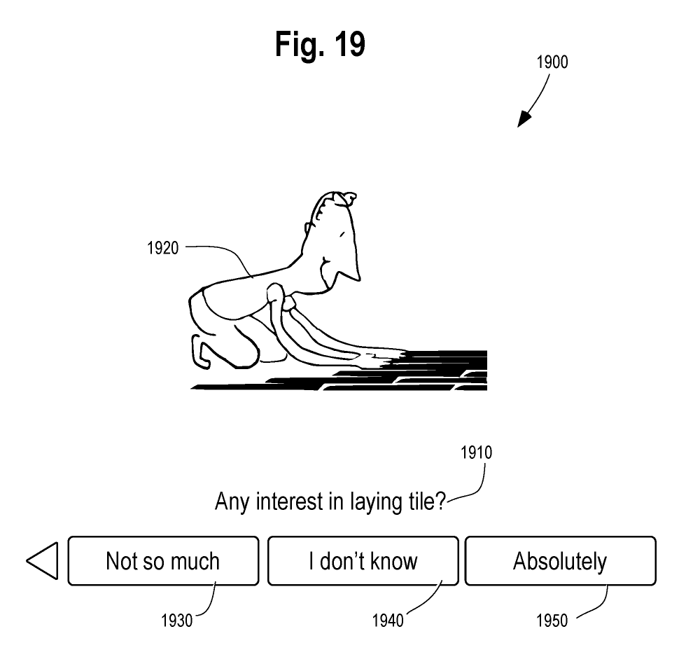

FIG. 19 is a screenshot of a second assessment question screen in a system and method for connecting a user to an employment resource tailored to the user, using an assessment questionnaire on a computational device.

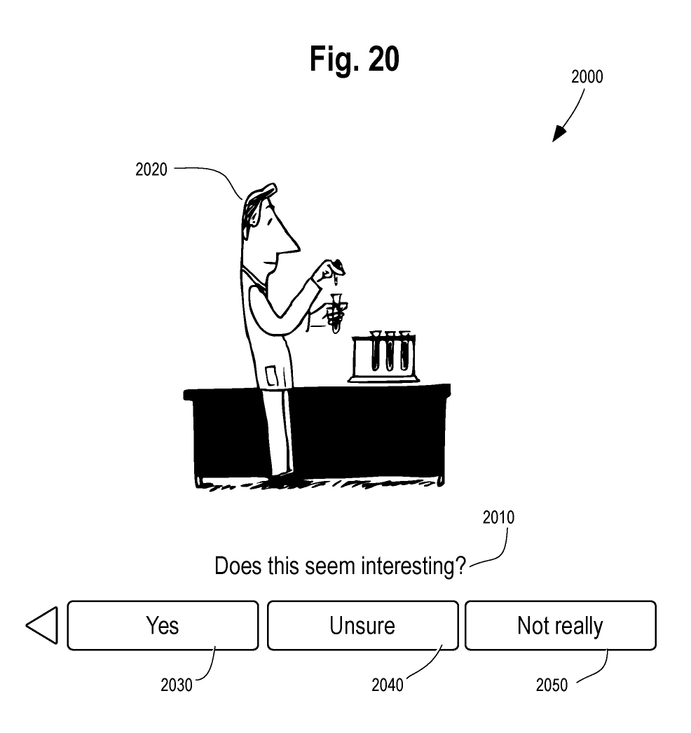

FIG. 20 is a screenshot of a third assessment question screen in a system and method for connecting a user to an employment resource tailored to the user, using an assessment questionnaire on a computational device.

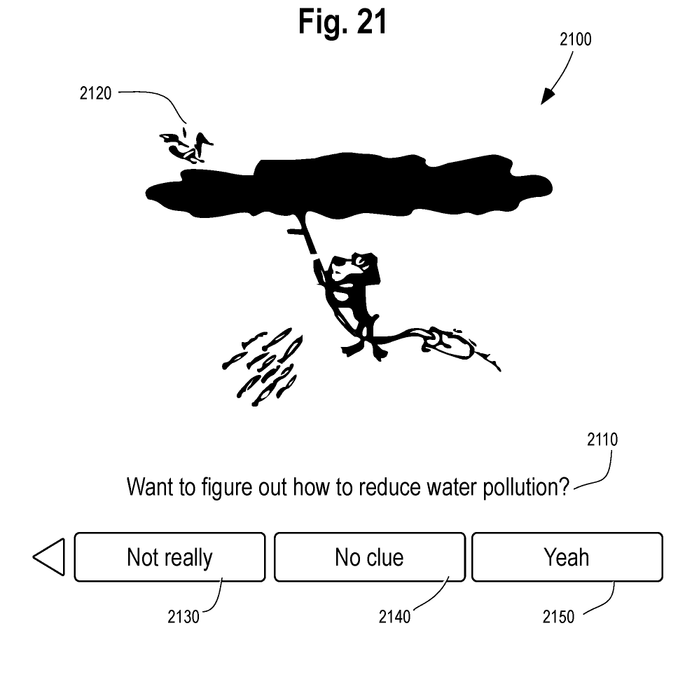

FIG. 21 is a screenshot of a fourth assessment question screen in a system and method for connecting a user to an employment resource tailored to the user, using an assessment questionnaire on a computational device.

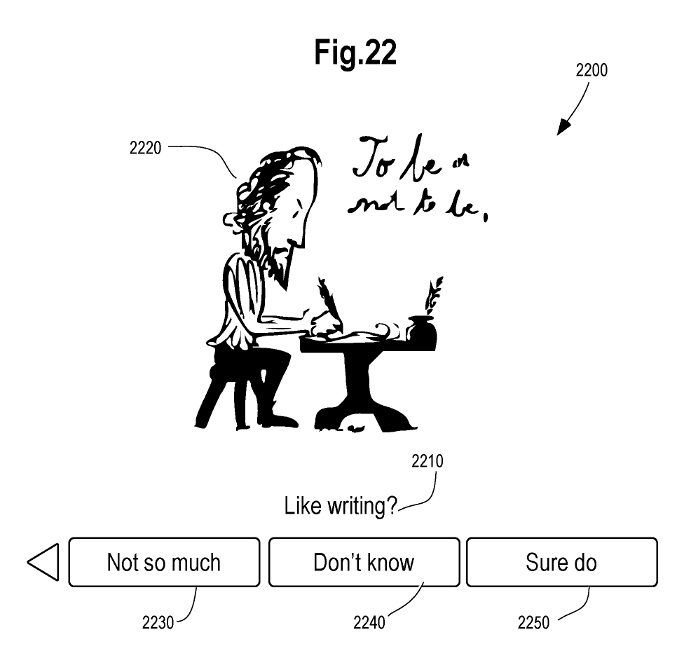

FIG. 22 is a screenshot of a fifth assessment question screen in a system and method for connecting a user to an employment resource tailored to the user, using an assessment questionnaire on a computational device.

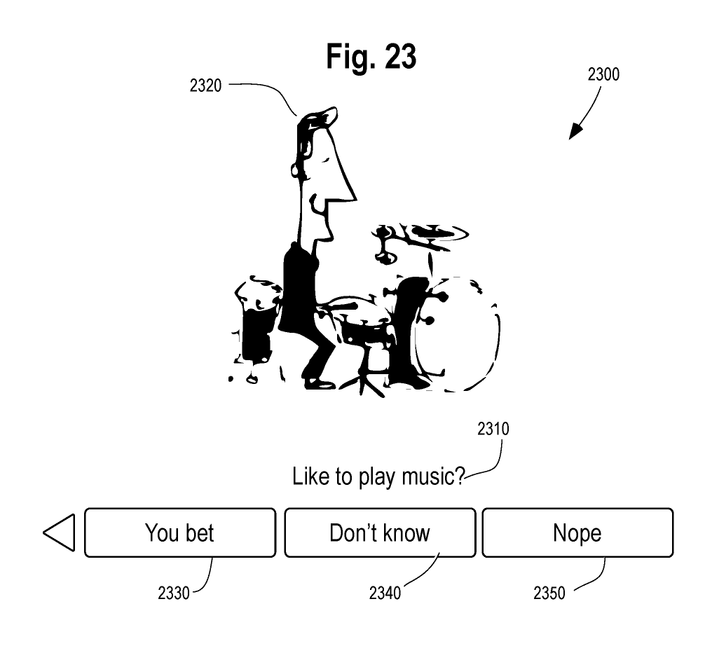

FIG. 23 is a screenshot of a sixth assessment question screen in a system and method for connecting a user to an employment resource tailored to the user, using an assessment questionnaire on a computational device.

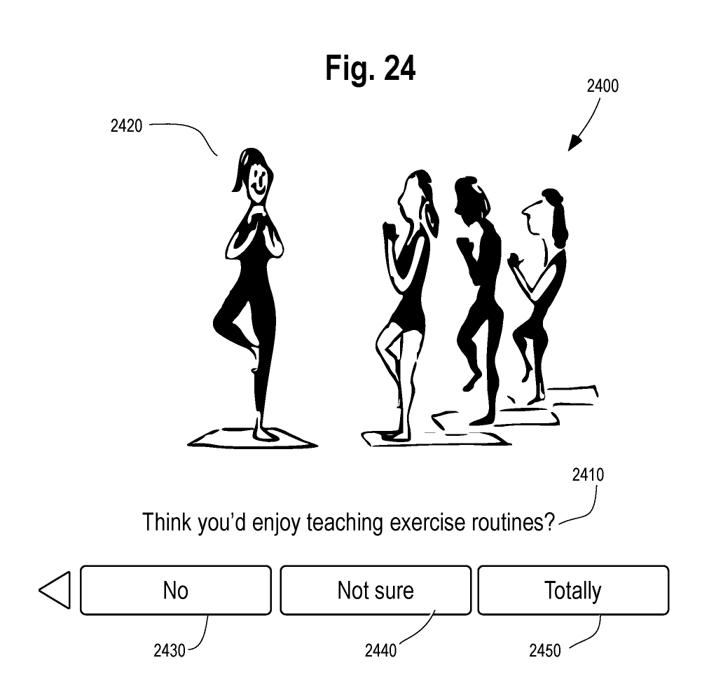

FIG. 24 is a screenshot of a seventh assessment question screen in a system and method for connecting a user to an employment resource tailored to the user, using an assessment questionnaire on a computational device.

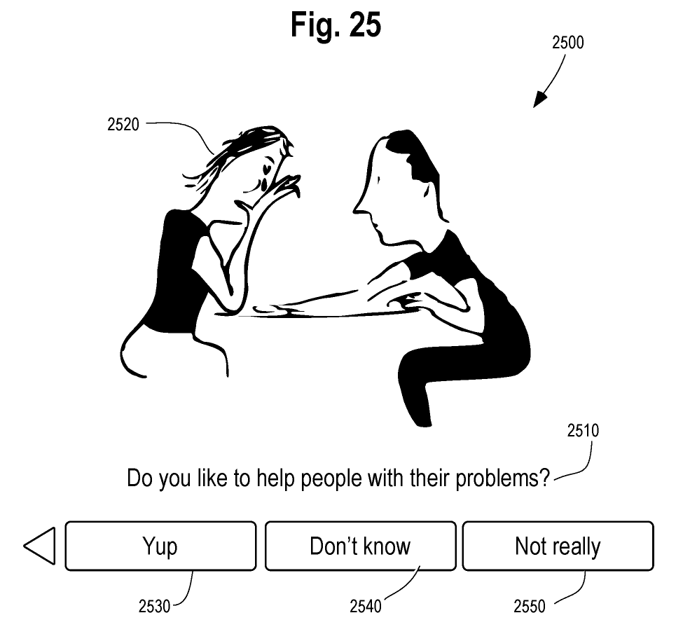

FIG. 25 is a screenshot of an eighth assessment question screen in a system and method for connecting a user to an employment resource tailored to the user, using an assessment questionnaire on a computational device.

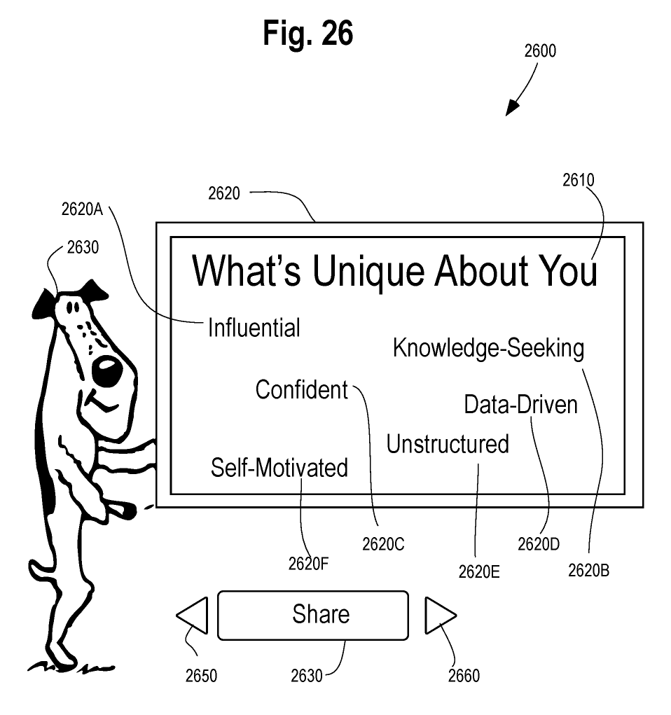

FIG. 26 is a screenshot of an attributes screen in a system and method for connecting a user to an employment resource tailored to the user, using an assessment questionnaire on a computational device.

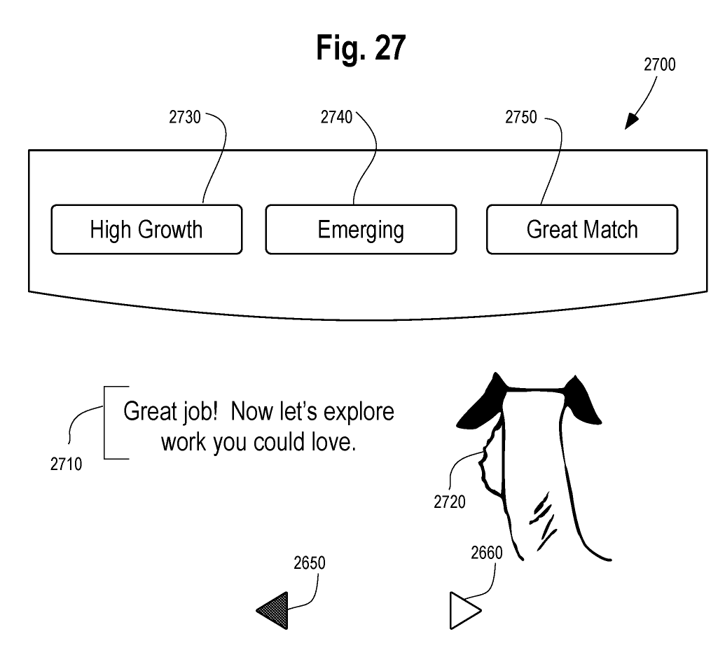

FIG. 27 is a screenshot of the job category suggestion screen in a system and method for connecting a user to an employment resource tailored to the user, using an assessment questionnaire on a computational device.

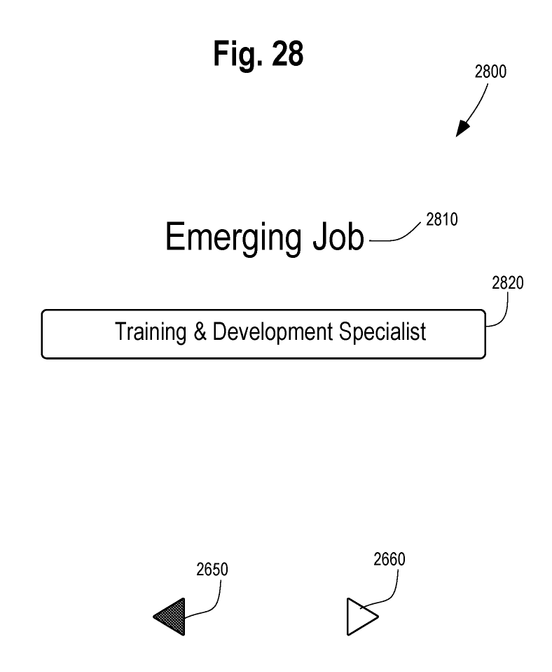

FIG. 28 is a screenshot of a screenshot of an emerging job screen in a system and method for connecting a user to an employment resource tailored to the user, using an assessment questionnaire on a computational device.

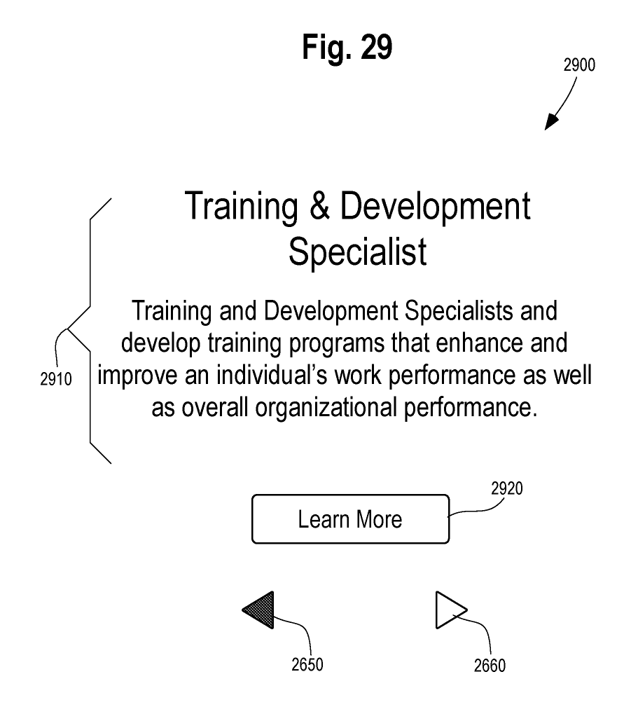

FIG. 29 is a screenshot of an emerging job details screen in a system and method for connecting a user to an employment resource tailored to the user, using an assessment questionnaire on a computational device.

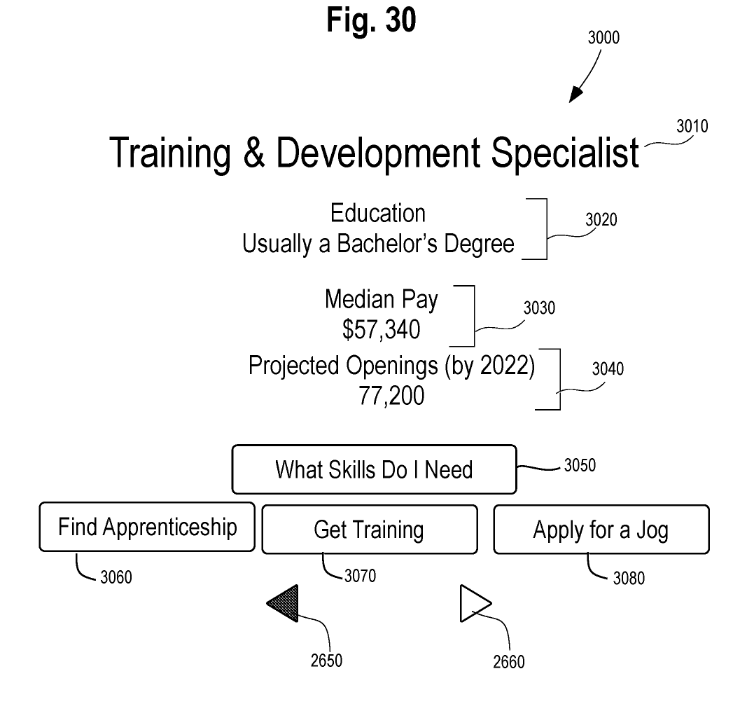

FIG. 30 is a screenshot of an emerging job further details screen in a system and method for connecting a user to an employment resource tailored to the user, using an assessment questionnaire on a computational device.

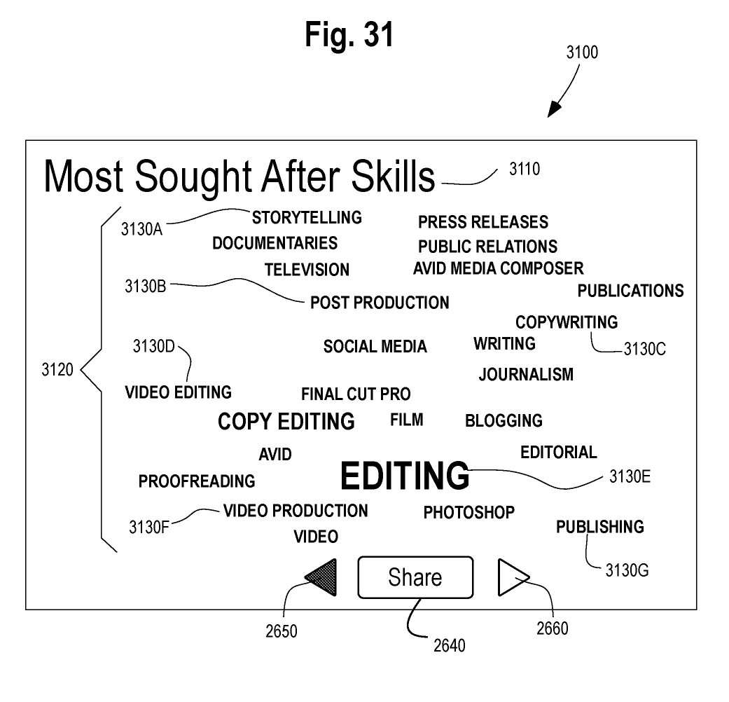

FIG. 31 is a screenshot of an emerging job skills screen in a system and method for connecting a user to an employment resource tailored to the user, using an assessment questionnaire on a computational device.

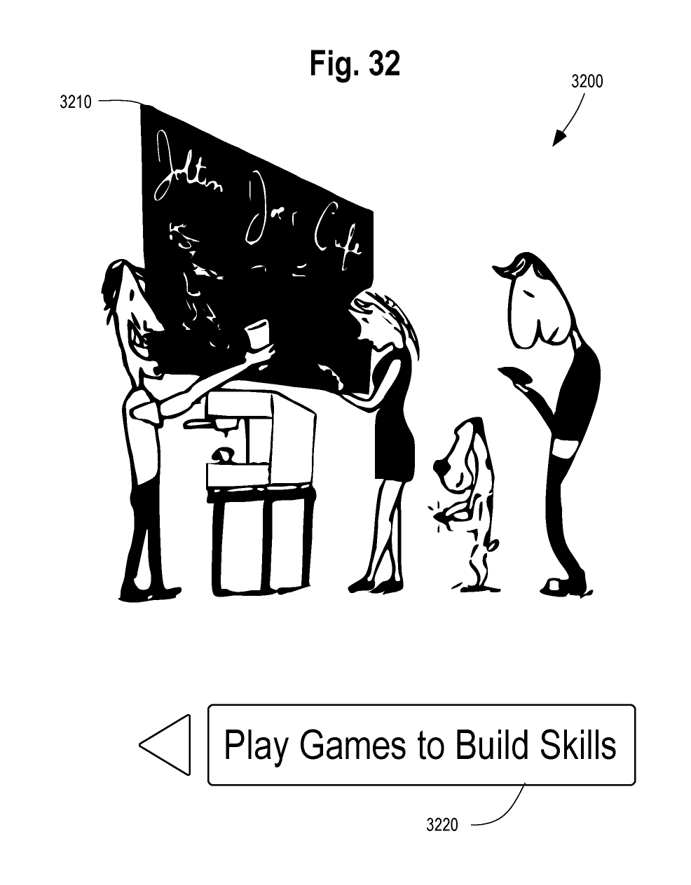

FIG. 32 is a screenshot of a game introductory screen in a system and method for connecting a user to an employment resource tailored to the user, using a game played on a computational device.

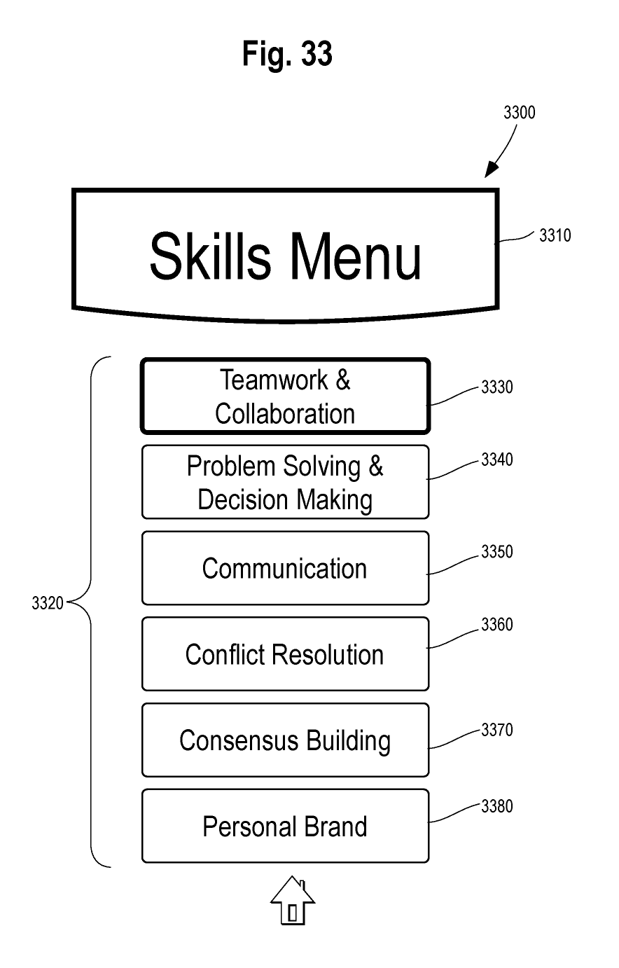

FIG. 33 is a screenshot of a skills menu in a system and method for connecting a user to an employment resource tailored to the user, using a game played on a computational device.

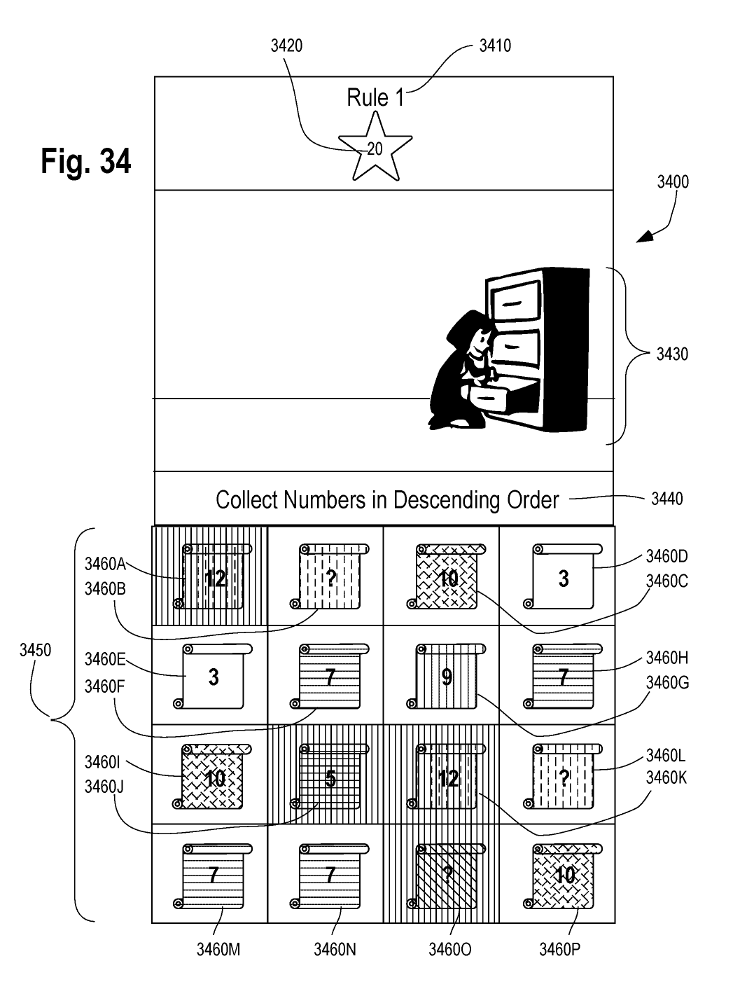

FIG. 34 is a screenshot of a first game screen in a system and method for connecting a user to an employment resource tailored to the user, using a game played on a computational device.

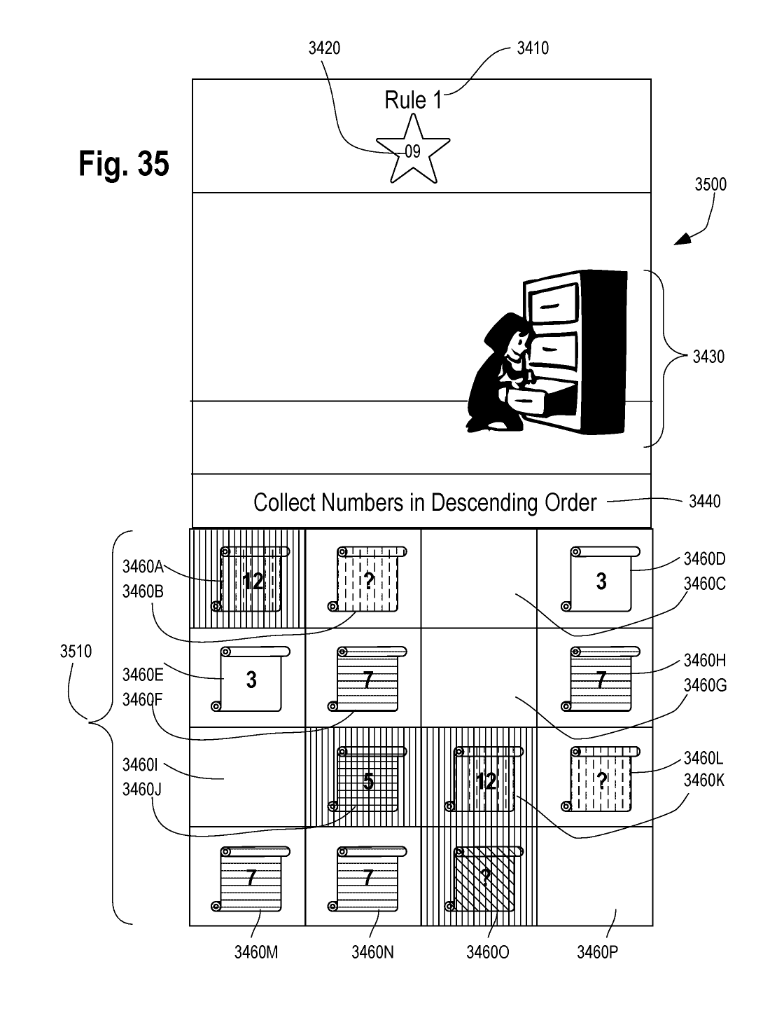

FIG. 35 is a screenshot of a second game screen in a system and method for connecting a user to an employment resource tailored to the user, using a game played on a computational device.

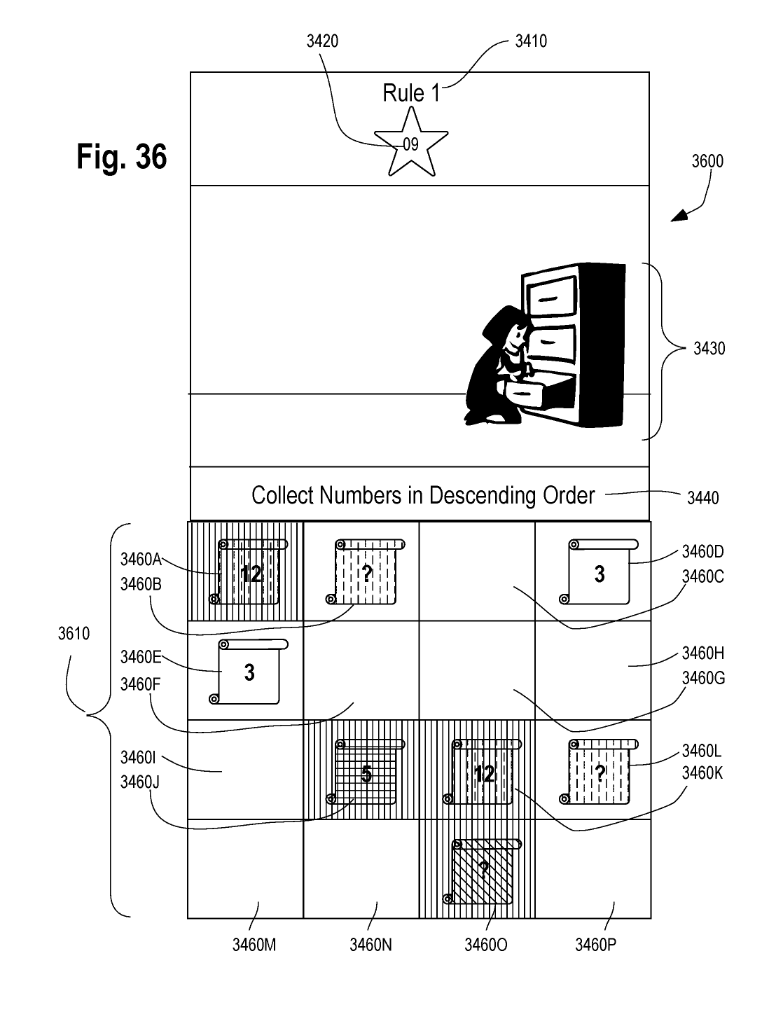

FIG. 36 is a screenshot of a third game screen in a system and method for connecting a user to an employment resource tailored to the user, using a game played on a computational device.

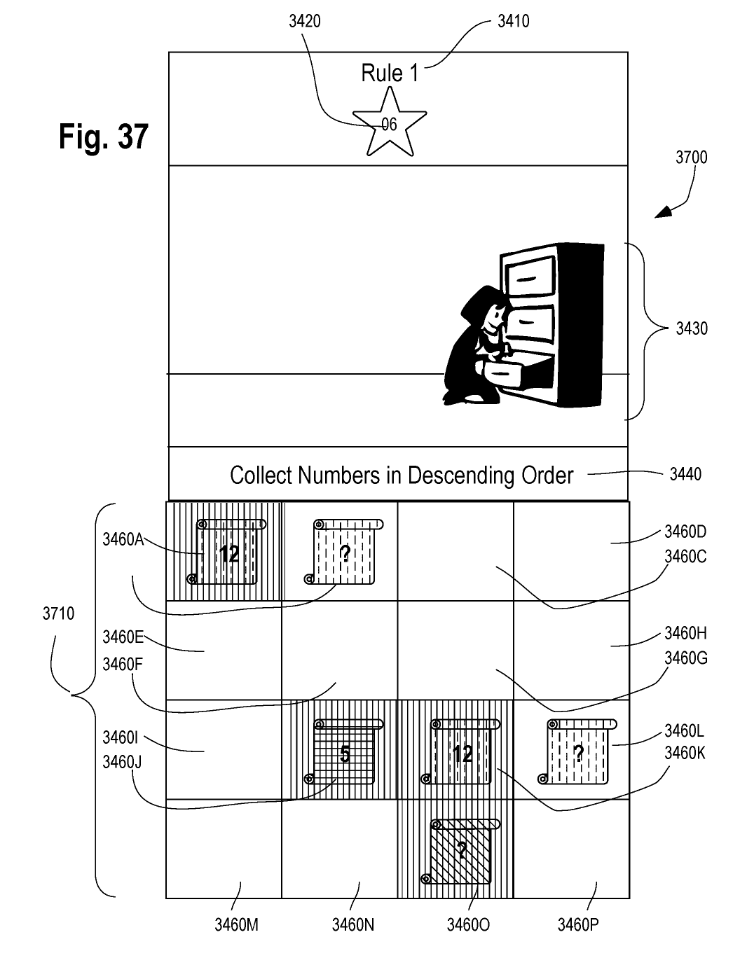

FIG. 37 is a screenshot of a fourth game screen in a system and method for connecting a user to an employment resource tailored to the user, using a game played on a computational device.

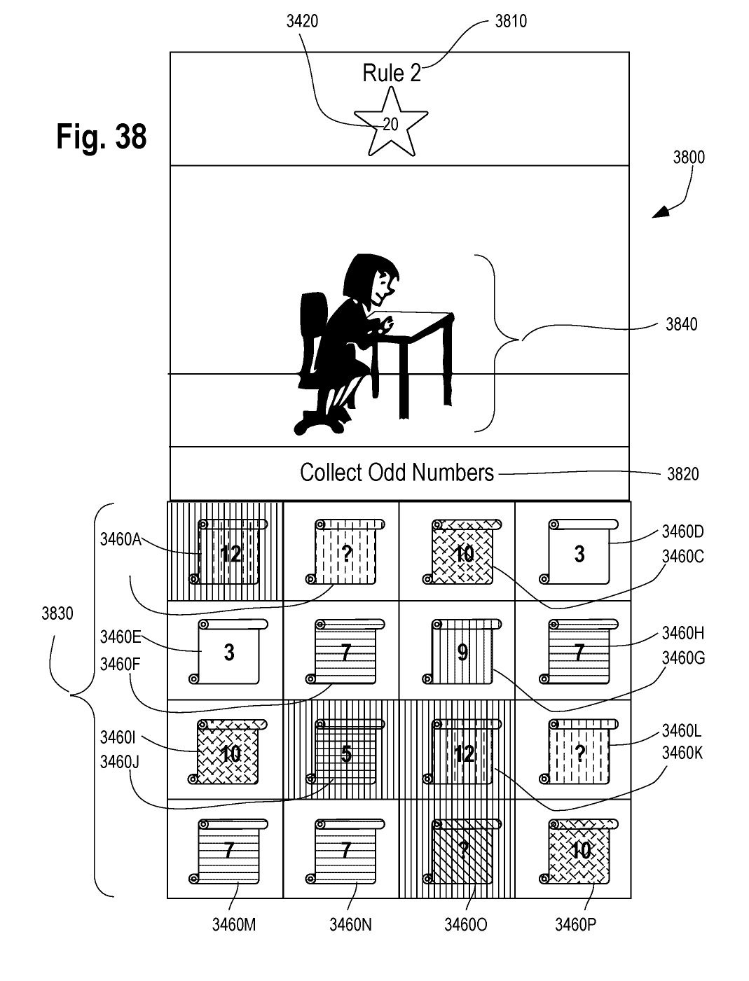

FIG. 38 is a screenshot of a fifth game screen in a system and method for connecting a user to an employment resource tailored to the user, using a game played on a computational device.

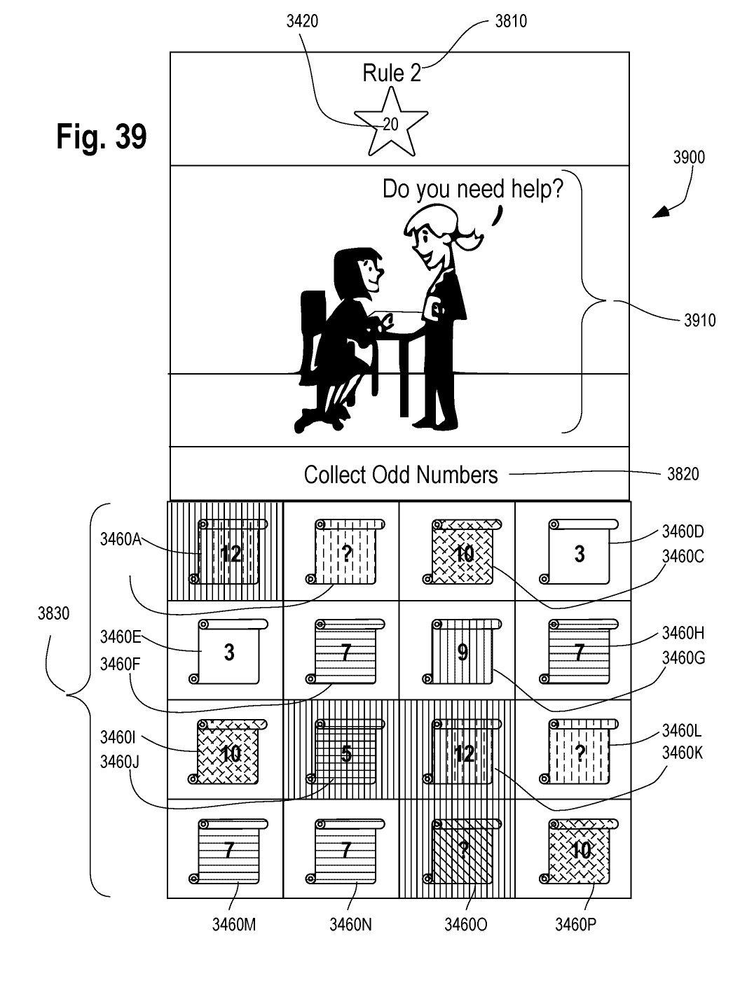

FIG. 39 is a screenshot of a sixth game screen in a system and method for connecting a user to an employment resource tailored to the user, using a game played on a computational device.

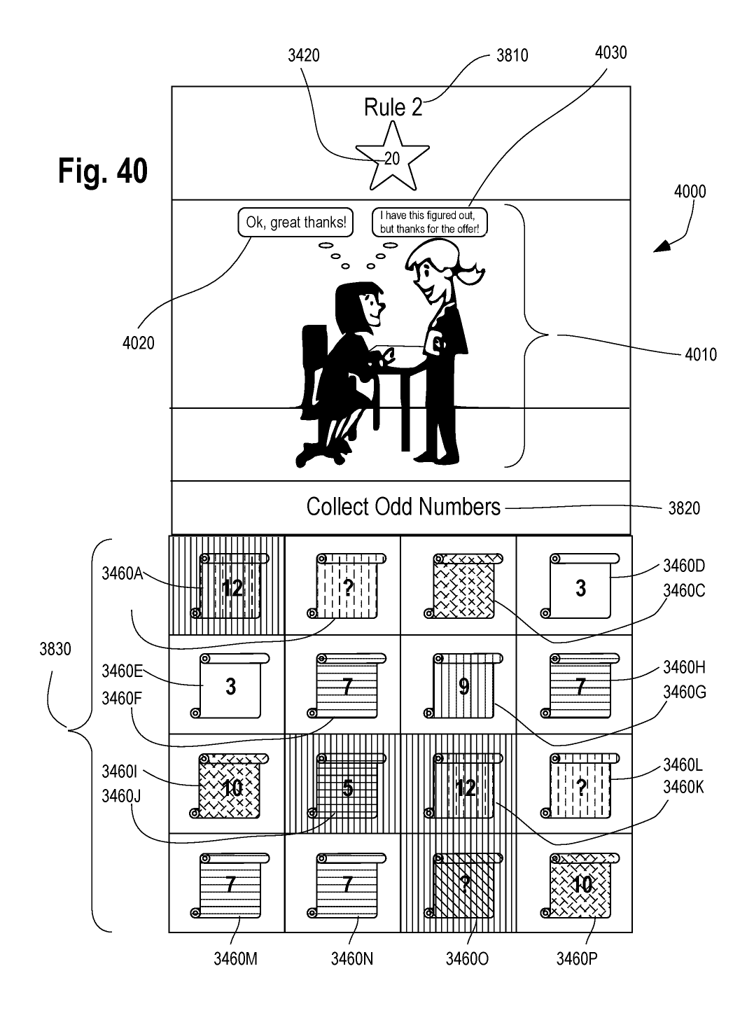

FIG. 40 is a screenshot of a seventh game screen in a system and method for connecting a user to an employment resource tailored to the user, using a game played on a computational device.

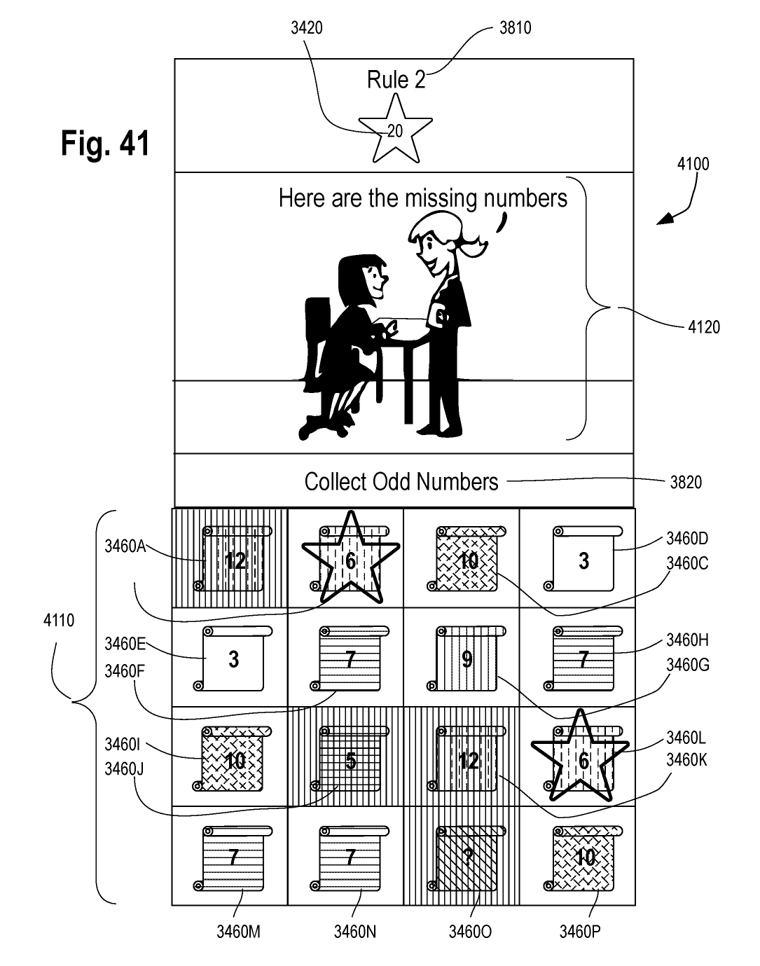

FIG. 41 is a screenshot of an eighth game screen in a system and method for connecting a user to an employment resource tailored to the user, using a game played on a computational device.

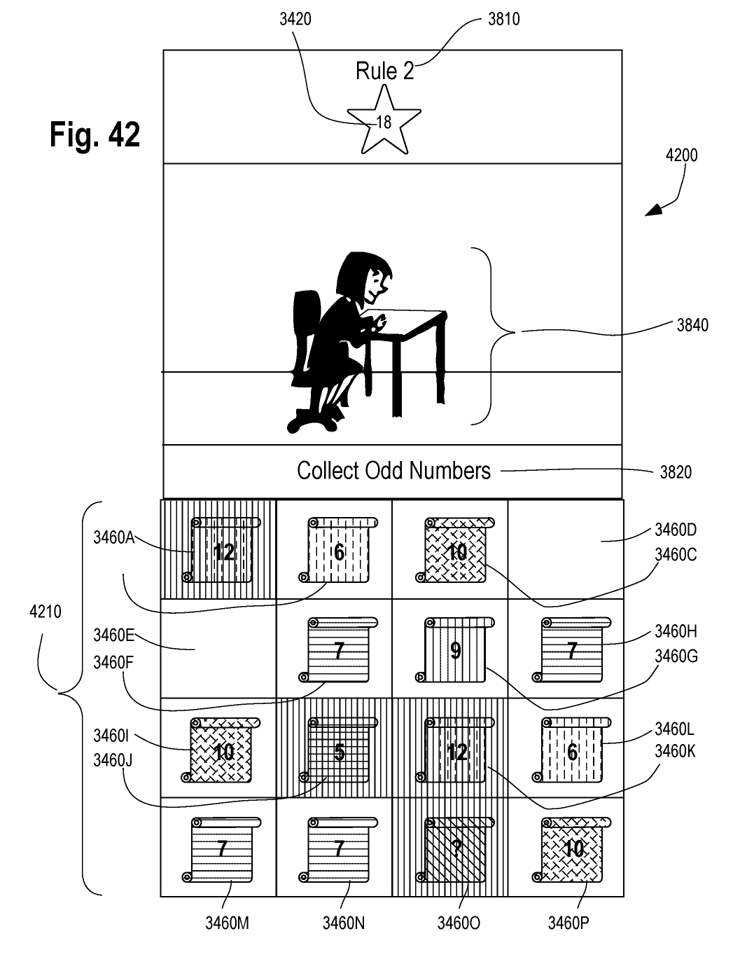

FIG. 42 is a screenshot of a ninth game screen in a system and method for connecting a user to an employment resource tailored to the user, using a game played on a computational device.

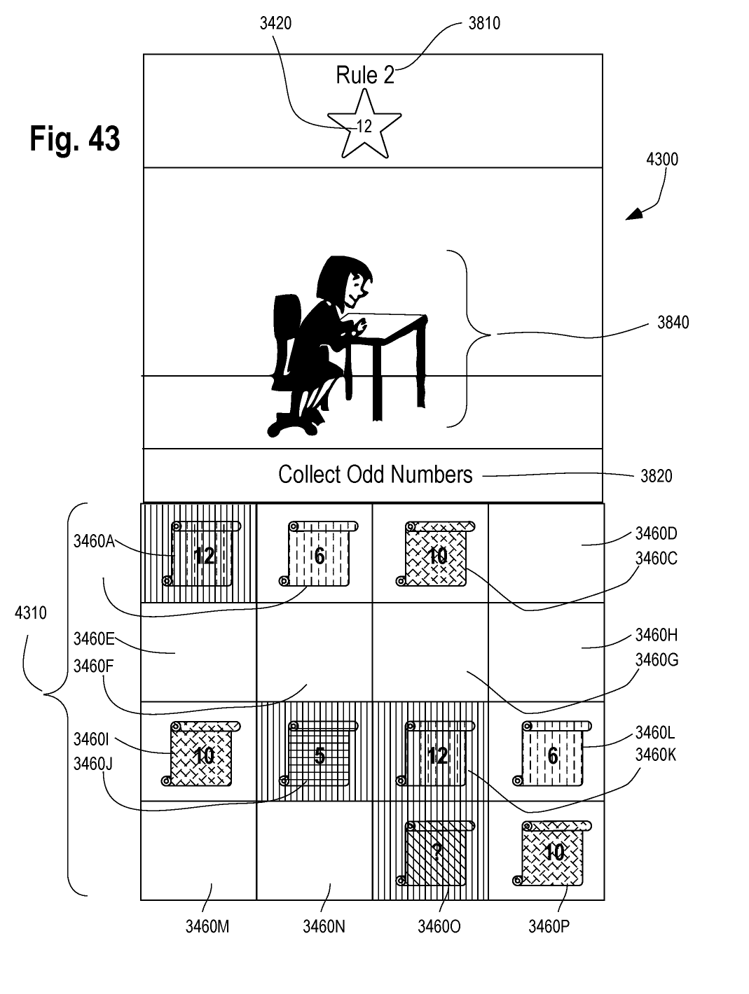

FIG. 43 is a screenshot of a tenth game screen in a system and method for connecting a user to an employment resource tailored to the user, using a game played on a computational device.

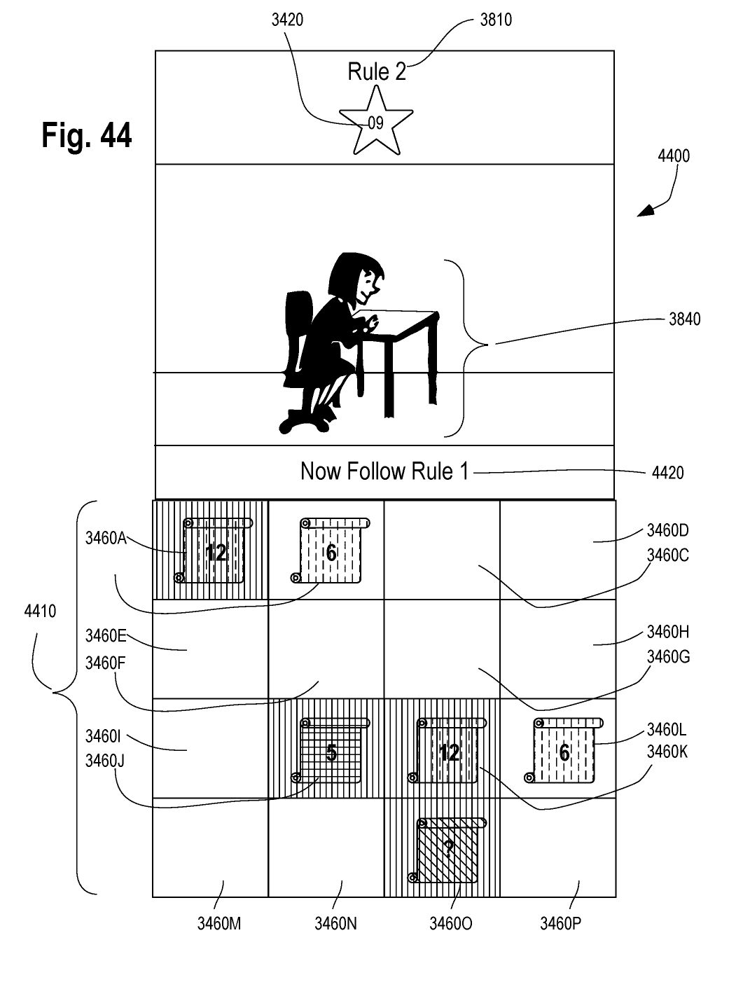

FIG. 44 is a screenshot of an eleventh game screen in a system and method for connecting a user to an employment resource tailored to the user, using a game played on a computational device.

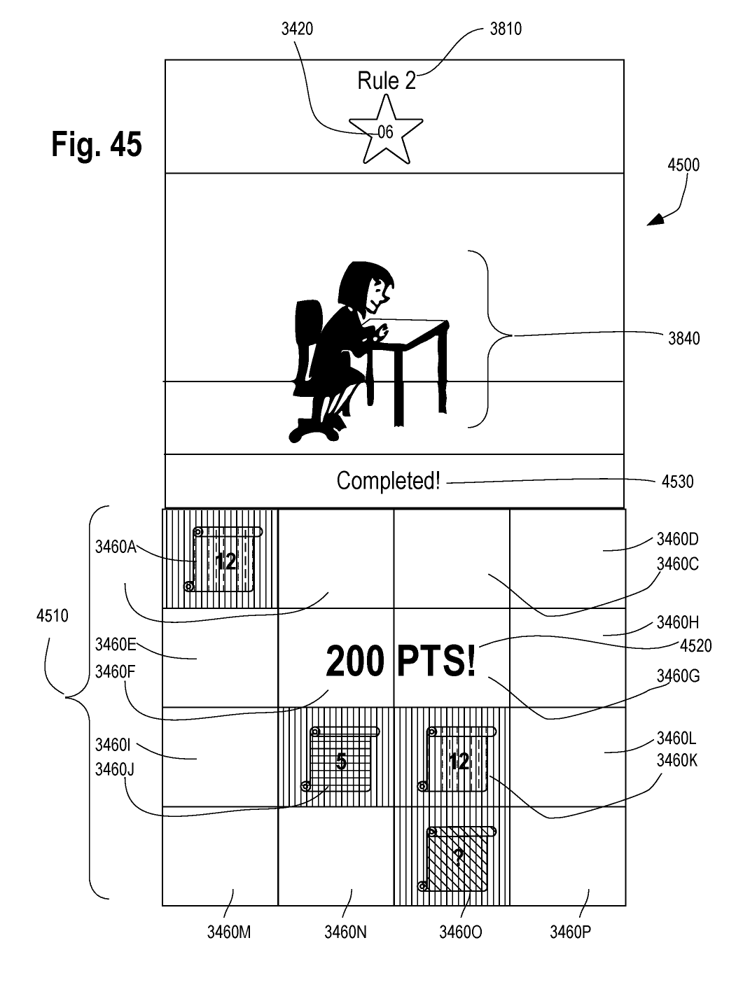

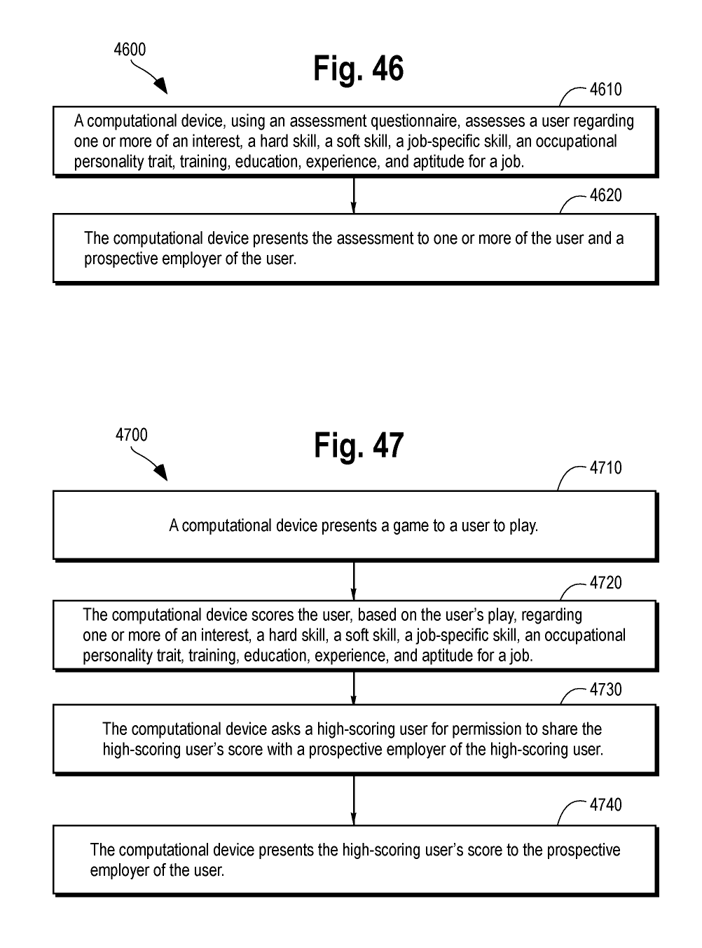

FIG. 45 is a screenshot of a twelfth game screen in a system and method for connecting a user to an employment resource tailored to the user, using a game played on a computational device.

FIG. 46 is a flow chart of a method for connecting a user to an employment resource tailored to the user using a game played on a computational device.

FIG. 47 is a flow chart of a method for connecting a user to an employment resource tailored to the user, using an assessment questionnaire on a computational device.

### DETAILED DESCRIPTION

Embodiments of the invention relate in general to a system and method for connecting a user to an employment resource tailored to the user. Further embodiments of the invention connect an employer to users. Other embodiments of the invention connect a user to an employment resource. An employment resource comprises one or more of customized pathways, job recommendations, new hire recommendations, a link to lifestyle information, a link to education, a link to training, a link to financial aid, a link to an internship, a link to a mentorship, employer information, new hire information, a job opening, a job application portal, a game configured to assess the user, and another employment resource. For example, the game may be configured to assess the user regarding one or more of a hard skill, a soft skill, a job-specific skill, an occupational personality trait, an aptitude, and another user criterion. A soft skill comprises a workplace competency.

Throughout this application, the word “job” is used to refer both to a specific position and to an occupation. Generally, the system's recommendations will relate to occupations rather than specific positions, although recommendations of specific positions are also possible according to embodiments of the invention. According to embodiments of the invention, a system and method connects a user to employment resources. For example, the system and method connects a user to employment resources tailored to the user. For example, the system comprises one or more of a mobile platform and an online platform. For example, the system and method connects a user to one or more of a user assessment, training, and one or more career opportunities. For example, the system device ranks at least two users for their prospective appropriateness to the prospective employer.

According to further embodiments of the invention, the career opportunities comprise high-growth, in-demand career opportunities. For example, high growth jobs have 75,000 or more anticipated openings in the United States within the next six years. For example, high growth industries may comprise one or more of aerospace, advanced manufacturing, automotive, biotechnology, construction, energy, financial services, geospatial, health care, leisure and hospitality, information technology, retail, and transportation.

Embodiments of the invention use one or more of social data, predictive modeling, and predictive gaming to match users to one or more of a job and an industry in which they are likely to succeed. According to embodiments of the invention, a game assesses the user for one or more of a hard skill, a soft skill, a job-specific skill, an occupational personality trait, and aptitude. The game uses a simple, elegant, and interesting mobile platform. The game determines people's skills and aptitudes in an original, fun, interactive way. For example, the game focuses on users from one or more of Generation Y and Generation Z.

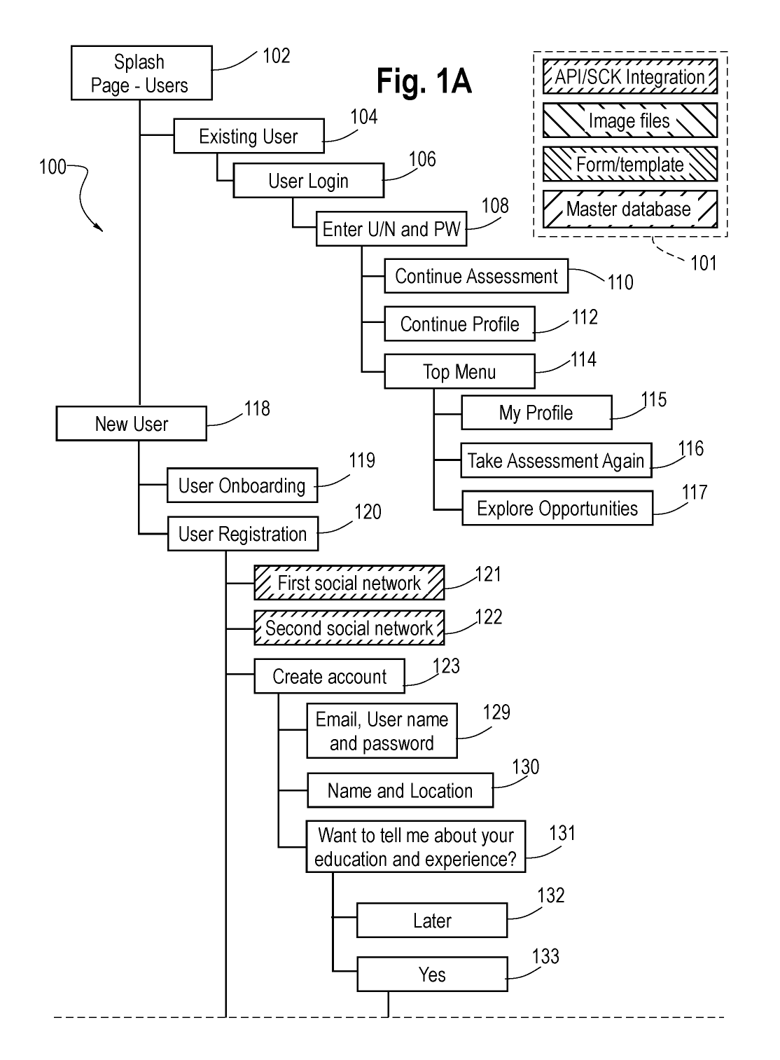

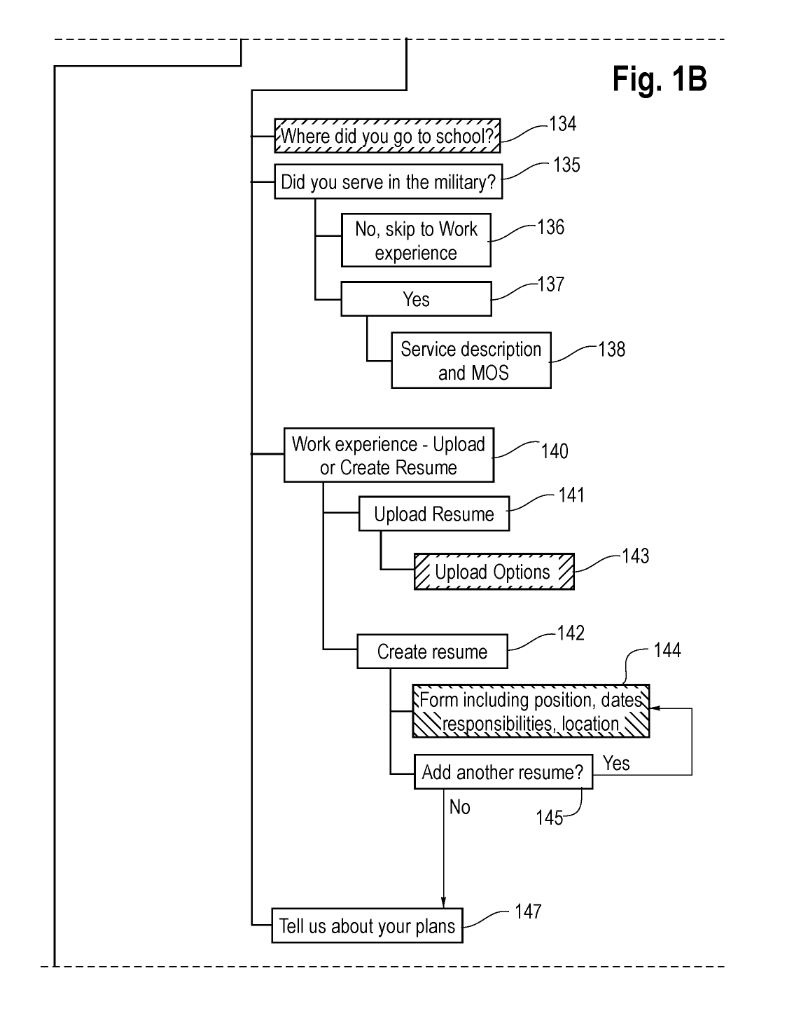

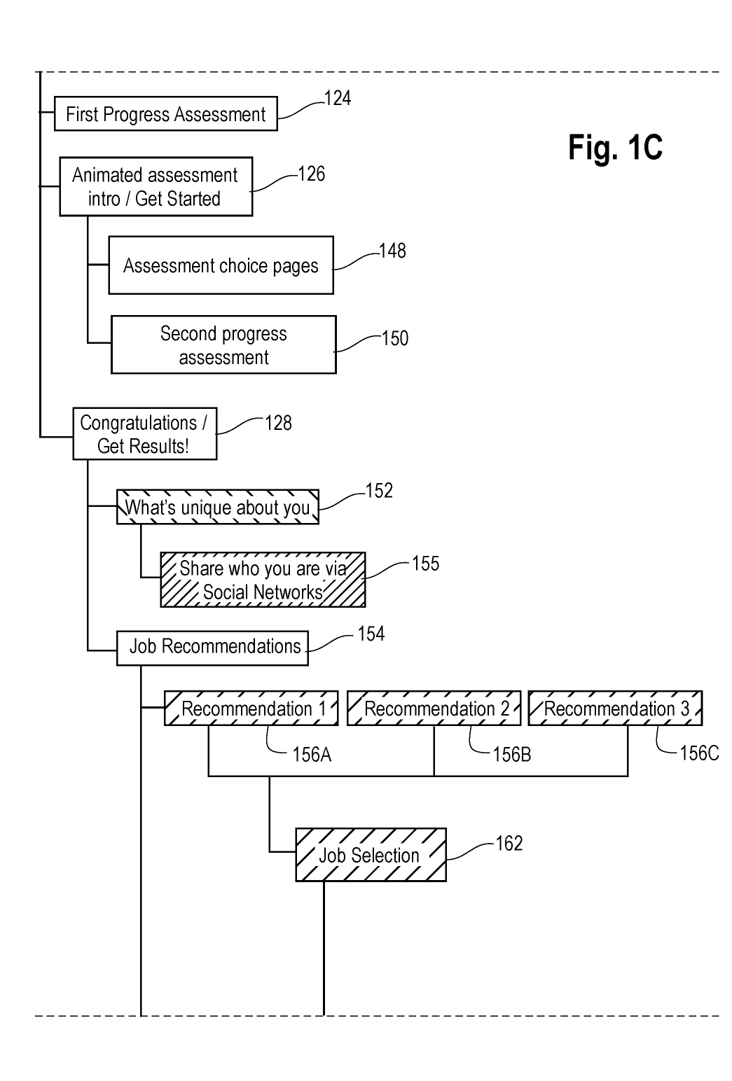

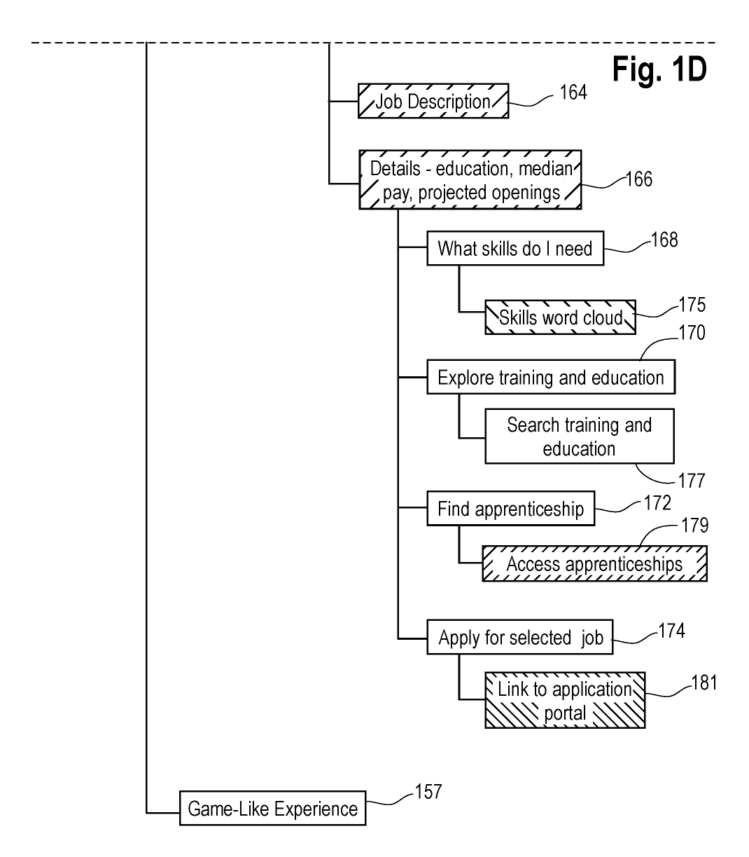

Embodiments of the invention employ a computational device. For example, the computational device comprises one or more of a computer, a mobile phone, a tablet, and another computational device. FIG. 1 is a site map 100 of principal components of a system and method for connecting a user to an employment resource tailored to the user. As shown by a legend box 101, certain components of the site map 100 belong to one or more of application programming interface (API)/software development kit (SDK) integration, image files, forms/templates, and a master database.

The site map 100 comprises a user splash page 102. The user splash page 102 asks a user whether the user is an existing user with a previously created account or a new user.

If the user is an existing user, the user is routed to existing user page 104 and then is routed onto user login page 106, where the user is asked to log in to his or her account. On “enter username and password” page 108, the user enters a username and a password. After entering the username and the password, the user is routed to one or more of a continue assessment page 110, a continue profile page 112, and a top menu 114. From the top menu 114, the user is routed to one or more of a “my profile” page 115, a “take assessment again” page 116, and an “explore opportunities” page 117.

If the user is a new user, from the splash page 102, the user is routed to new user page 118. From the new user page 118, the user is routed to one or more of a user onboarding page 119 and a user registration page 120.

From the user registration page 120, the user is routed to one or more of a first social network 121, a second social network 122, an account creation page 123, a first progress assessment page 124, an animated assessment introduction/get started page 126, and a congratulations/get results page 128.

From the account creation page 123, the user is directed to input one or more of an email, username and password page 129, a name and location page 130, and a “want to tell me about your education and experience?” page 131. From the “want to tell me about your education and experience?” page 131, the user is routed, based on the user's input, to one or more of an education/experience “later” page 132 and an education/experience “yes” page 133.

From the education/experience “yes” page 133, the user is routed to a “where did you go to school?” page 134. The system then routes the user to a “did you serve in the military?” page 135. From the “did you serve in the military?” page 135, the user is routed, based on the user's input, to one or more of a military “no” page 136 and a military “yes” page 137.

From the military “yes” page 137, the user is next routed to a “service description and MOS” page 138 at which the user inputs one or more of a description of the user's military service and a description of the user's military occupational specialty (MOS). Then the user is routed to a work experience page 140. The work experience page invites the user to do one or more of uploading a resume and creating a resume. From the military “no” page 136, the user is directly routed to the work experience page 140.

From the work experience page 140, the user is next directed to one or more of an upload resume page 141 and a create resume page 142. At this page, the user uploads one or more resumes the user may previously have created. From the upload resume page 141, the user is directed to an upload options page 143. The upload options page 143 offers the user various upload options. For example, the upload options page 143 offers the user the opportunity to do one or more of upload the resume from a device, upload the resume from a cloud-based drive, and upload the resume from another source. The upload options page 143 further offers the user a range of resume formats including one or more of portable data format (PDF), rich text format (RTF), plain text format (TXT), Word document format (DOC), and another resume format.

At the create resume page 144, the user is invited to create a resume. At add resume page 145, the user is invited to add another resume. If the user elects to create another resume, the user is directed back to the create resume page 144. If the user elects not to create another resume, then the user is directed to a “tell us about your plans” page 147.

The system then directs the user to the first progress assessment page 124, where the system assesses the progress the user is making navigating the system. Then the system directs the user to the animated assessment introduction/get started page 126, where the system uses an animated assessment to do one or more of introduce the assessment process and get the user started on the assessment. Next the system directs the user to assessment choice pages 148, where the user is presented with choices that enable the system to assess one or more of the user's aptitudes and the user's interests. For example, the system presents the user with one or more assessment choice pages asking the user to indicate interest in an activity by choosing one of three options. Then the system directs the user to one or more second progress assessment pages 150. While not specifically called out in the site map 100, the system may comprise further pages to denote the user's progress, the further pages interspersed at other points in the system.

The system then directs the user to the congratulations/get results page 128, where the system provides the user with one or more of congratulations and provisional results of the assessment. The system then directs the user to a “what's unique about you” page 152 that invites the user to describe what the user sees as one or more of the user's job aptitudes and the user's job skills. At a “share who you are” page 155, the system then invites the user to share information about one or more of the user's job aptitudes and the user's job skills. For example, the “share who you are” page 155 invites the user to share information via a social network.

The system then directs the user to a job recommendations page 154 comprising links to one or more jobs the system recommends for consideration by the user. The system then directs the user to one or more specific job recommendation pages 156A, 156B, and 156C. For example, the system directs the user to between three and five specific job recommendation pages 156A-156C.

The system then sends the user to a job selection page 162 at which the user is invited to click on a specific job recommendation from one of the specific job recommendation pages 156A-156C that the user finds to be of interest. For example, the user swipes the job selection page 162 to save to the user's profile a selected job recommendation page 156A-156C.

The system then sends the user to a selected job description page 164 that describes the job selected by the user. The system then sends the user to a job details page 166 that describes details of the job selected by the user. For example, the details describes by the system on the job details page 166 comprise one or more of education, median pay, projected openings, and other selected job details. From the job details page 166, the system sends the user to one or more of a “what skills do I need” page 168, a “get training” page 170, a “find apprenticeship” page 172, and an “apply for a job” page 174.

The system then sends the user to the “what skills do I need” page 168 describing skills the user needs to perform the selected job. The system then sends the user to a skills work cloud page 175 comprising a work cloud describing skills needed to perform the selected job.

The system then sends the user to the “get training” page 170, where the system invites the user to explore one or more of options for training needed to perform the selected job and options for education needed to perform the selected job. Next the system sends the user to a “search training and education” page 177 permitting the user to search one or more of training needed for the selected job and education needed for the selected job. For example, at the “search training and education” page 177, the system allows the user to search by locations for one or more of training needed for the selected job and education needed for the selected job.

The system then sends the user to the “find apprenticeship” page 172, where the system invites the user to find apprenticeships needed to perform the selected job. Next the system sends the user to an “access apprenticeships” page 179 permitting the user to search apprenticeships needed for the selected job.

The system then sends the user to the “apply for a job” page 174, where the system invites the user to apply for the selected job. The system then sends the user to a “link to application portal” page 181 that links the user to an application portal. The application portal allows the user to do one or more of apply for the selected job, view an aggregated job posting by an employer that is not currently a user of the system, view an aggregated job posting by an employer that is currently a user of the system, view a direct job posting by an employer user, view a link to a website of an employer user.

The system then provides the user with a game-like experience page 157. Through the game-like experience page 157, the system offers the user an opportunity to go through a game-like experience designed to enable the user to build workplace competencies, which are also known as soft skills.

FIGS. 2-17 are a series of screenshots of a system and method for connecting a user to an employment resource tailored to the user, using a game played on a computational device. The system sequentially presents to a user the screenshots comprised in the FIGS. 2-17. These figures demonstrate how embodiments of the invention assess one or more of employment interests and employment aptitudes of a user.

Prior to FIG. 2, as part of an onboarding process, the user creates a user account, signs into the user account, and enters basic information such as name, geographic information, education information, and so on. For example, the geographic information comprises one or more of a zip code, a city, a county, a state, a province, a region, and another geographic region. For example, the education information comprises one or more of a highest level of education completed, an institution attended by the user, a degree received at an institution, an area of study at an institution, an academic honor received at the institution, a grade received at the institution, a class attended at the institution, a class ranking at the institution, and other education information. For example, the institution comprises one or more of a high school, a preparatory school, a college, a university and another institution.

FIG. 2 is a screenshot of a success screen 200 shown to a user in a system and method for connecting a user to an employment resource tailored to the user, using a game played on a computational device. For example, after the onboarding process is complete, FIG. 2 depicts the success screen 200 shown to the user. As depicted, the success screen 200 comprises an success word 210. As depicted, the success word 210 comprises the word, “Success!” For example, the success screen 200 comprises one or more of text and graphics indicating that the user has successfully enrolled in the system.

For example, while on the success screen 200, the system plays for the user a message. The user may for example virtually meet an animated coach/guide to the system. For example, the animated coach/guide is named Doug. For example, the system plays a voiceover that says to the user, “Want to find out what you'll love to do? Want to know how to get there. Follow me . . . Oh, and I'm Doug, by the way.” The success screen 200 further comprises the back button 220 that allows the user to return to the previous screen.

FIG. 3 is a screenshot of welcome screen 300 in a system and method for connecting a user to an employment resource tailored to the user, using a game played on a computational device. As depicted, the welcome screen 300 comprises a progress bar 310. The progress bar 310 comprises a legend reading, “Points.” The progress bar 310 is configured to indicate points accumulated by a user by using the system and method for connecting a user to an employment resource tailored to the user. The welcome screen 300 further comprises an enter button 320. When clicked, the enter button 320 allows the user to enter into the system and method for connecting a user to an employment resource tailored to the user by scoring one or more of employment interests and employment aptitudes of a user.

For example, while on the welcome screen 300, the system plays a voiceover that says to the user, “So, you're about to be part of a couple of different stories. You'll do stuff that will give the scientists who live inside your phone an idea about what you might love to do. This bar here shows your progress. When you reach the top, we'll be able to tell you what kinds of things you'll be great at and how to get there. You ready?”

FIG. 4 is a screenshot of an optional format selection screen 400 in a system and method for connecting a user to an employment resource tailored to the user, using a game played on a computational device. FIG. 4 depicts an optional format selection screen 400. The optional format selection screen 400 allows the user to select a format the user will employ to navigate the system and method system and method for connecting a user to an employment resource tailored to the user by scoring one or more of employment interests and employment aptitudes of a user. As depicted, the format selection screen 400 offers the user a choice between a mobile virtual reality (VR) button 410 and a mobile button 420. The format selection screen 400 also comprises a VR icon 430 and a mobile icon 440. The user can thereby select a preferred format. The format selection screen 400 further comprises a help icon 450 that the user can press at any time to receive help from the system.

FIG. 5 is a screenshot of a first game selection screen 500 in a system and method for connecting a user to an employment resource tailored to the user, using a game played on a computational device. The first game selection screen 500 allows the user to select a reward system that the user will employ while navigating the system. As depicted, the first game selection screen 500 offers the user a choice between saving the world by selecting a save button 505. The system does not offer the user an opportunity to solve a mystery by selecting a solve button 510 because the user previously explored the solving experience. The second game selection screen offers the user further choices in addition to saving the world by selecting a save button 505, including building something tangible by selecting a build button 515, amassing points by selecting an amass button 520, creating beauty and expressing the user's self by selecting a create button 525, and restoring order by selecting a restore button 530. One or more of the save button 505, the solve button 510, the build button 515, the amass button 520, the create button 525, and the restore button 530 is associated with a choice in a career assessment questionnaire. As depicted, the first game selection screen 500 further comprises a save icon 535 operably connected with the save button 505, a solve icon 540 operably connected with the solve button 510 and now disabled because the user previously explored the solving experience, a build icon 545 operably connected with the build button 515, an amass icon 550 operably connected with the amass button 520, a create icon 555 operably connected with the create button 525, and a restore icon 560 operably connected with the restore button 530. The first game selection screen 500 further comprises the progress bar 310.

For example, while on the first game selection screen 500, the system plays a voiceover that says to the user, “Being in one of these stories is going to help you on your journey. And by the way, there's a scientific basis for all of this. So, what would you like to do?: Save the world? Solve a mystery? Build something tangible? Amass points? Create beauty and express yourself? Restore order?” For example, the system requires the user to explore at least four of the six potential story lines 505, 510, 515, 520, 525, and 530 before the system fills the progress bar 310.

FIG. 6 is a screenshot of a game play start screen 600 in a system and method for connecting a user to an employment resource tailored to the user, using a game played on a computational device. As depicted, the game start screen 600 offers the user a choice between a “work alone” button 610 and an assisted navigation button 620. If the user selects the “work alone” button 610, the user works on his own and has the option at any time to press the help icon 450 to receive help. For example, the system presents the help as help provided from an electronic coach. If the user selects the assisted navigation button 620, the user is guided by the system. The game start screen 600 further comprises the back button 220 and the progress bar 310. As depicted, the user selects the “work alone” button 610.

For example, while on the game start screen 600, the system plays a voiceover that says to the user, “Solve a mystery. Nice choice. Would you prefer to navigate on your own or would you like my help?” After the user selects the “work alone” button 610, the voiceover says, for example, “OK, you're on your own. If you need any hints, just click on the icon in the lower left.”

FIG. 7 is a screenshot of a “solve a mystery” screen 700 in a system and method for connecting a user to an employment resource tailored to the user, using a game played on a computational device. As depicted, the “solve a mystery” screen 700 comprises a mystery scene 710. As depicted, the mystery scene 710 comprises a still photograph taken from a film noir. As depicted, the mystery scene 710 creates for the user an immersive environment taken from Los Angeles in approximately the 1940's. While on the “solve a mystery” screen 700, the system plays a voiceover that describes the crime being solved and the user's objectives. The “solve a mystery” screen 700 further comprises the progress bar 310 and the help icon 450.

FIG. 8 is a screenshot of a first game screen 800 in a system and method for connecting a user to an employment resource tailored to the user, using a game played on a computational device. As depicted, the first game screen 800 comprises a first scene 810, a second scene 820, and a “click on the differences” legend 830. The system invites the user to compare the first scene 810 and the second scene 820, which at first appear virtually identical. As depicted, the first scene 810 comprises a matchbook from Musso Frank in Hollywood, Calif. The system further invites the user to find differences between the first scene 810 and the second scene 820 and, referring to the “click on the differences” legend 830, to click on the differences on one or more of the first scene 810 and the second scene 820. The first game screen 800 further comprises the progress bar 310, the back button 220, and the help icon 450.

FIG. 9 is a screenshot of a game mechanics selection screen 900 in a system and method for connecting a user to an employment resource tailored to the user, using a game played on a computational device. For example, while on the reward systems screen 900, the system plays a voiceover that congratulates the user and notes that he or she has gained points for successfully completing the first game.

Successful completion by the user suggests the user has observational skills. The successful completion by the user further constitutes a plot device able to move the storyline forward. Users will for example be offered a choice between three games. Alternatively, a single game is used to engage the user in the story line.

The reward systems screen 900 comprises a “find the next clue” legend 905. The reward systems screen 900 offers the user a choice between a plurality of reward systems, in this case, between three different options to get to Musso Frank. Each of the three options explores a different user aptitude. As depicted, the system offers the user options of following a map by selecting a spatial orientation button 910 configured to test the users spatial orientation skills, a cryptogram button 920 configured to test one or more of the user's problem solving skills and the user's cryptographic skills, and a persuasion button 930 configured to test the user's skills at persuading others. As depicted, the spatial orientation button 910 comprises a “follow a map” button 910. As depicted, the cryptogram button comprises a “solve a puzzle: open the portal” button 920. As depicted, the persuasion button comprises a ‘convince Morris to give you a lift” button 930. The user's selection provides the system with information regarding one or more of the user's aptitudes, occupational personality, plans for the future, experience, game performance, and the like.

As depicted, the reward systems screen 900 further comprises a map icon 940 operably connected with the spatial orientation button 910, a puzzle icon 950 operably connected with the cryptogram button 920, and a persuadable human icon 960 operably connected with the persuasion button 930. The reward systems screen 900 further comprises the progress bar 310 and the help icon 450. The user's level of success provides the system with information regarding one or more of the user's aptitudes, occupational personality, plans for the future, experience, game performance, and the like.

The system presents the user with the game to work through and presents options for the user to obtain help whenever desired from the electronic coach. Once an individual game is finished, the system presents the remaining reward systems again until the user solves the next game and is returned to the first game selection screen.

The system presents choices to the user in the context of a narrative story. The user's choices drive the system's presentation of game actions. For example, the system presents an animated story having a plurality of branches. The user chooses a branch based on a skill the user wishes to develop. For example, in a teamwork game, a user can do one or more of “go it alone,” i.e., work without assistance, and “ask for help,” i.e., work with assistance. The user's choices affect one or more of the animated story, a revealed gameboard, and points that can be scored.

FIG. 10 is a screenshot of a first game completion screen 1000 in a system and method for connecting a user to an employment resource tailored to the user, using a game played on a computational device. The first game completion screen 1000 comprises a congratulations legend 1010 and a “choose another game” button 1020. If the user pressed the “choose another game” button 1020, the system presents the user with the first game selection screen 500. The system cycles a maximum of three times so that the user can, if desired, try each of the three games. Then the user is returned to the first game selection screen 500.

The first game completion screen 1000 further comprises the progress bar 310 and the back button 220. For example, while on the first game completion screen 1000, the system plays a voiceover that congratulates the user for earning a certain number of points. For example, Doug congratulates the user for earning the certain number of points. For example, Doug encourages the user to continue. For example, the voiceover says, “This is great. The data scientists are getting lots of great stuff. Choose another game so we can learn more about you.”

FIG. 11 is a screenshot of a second game selection screen 1100 in a system and method for connecting a user to an employment resource tailored to the user, using a game played on a computational device. The second game selection screen 1100 allows the user to select a reward system that the user will employ while navigating the system. As depicted, the second game selection screen 1100 offers the user a choice between saving the world by selecting a save button 1105, solving a mystery by selecting a solve button 1110, building something tangible by selecting a build button 1115, amassing points by selecting an amass button 1120, creating beauty and expressing the user's self by selecting a create button 1125, and restoring order by selecting a restore button 1130. One or more of the save button 1105, the solve button 1110, the build button 1115, the amass button 1120, the create button 1125, and the restore button 1130 is associated with a choice in a career assessment questionnaire. As depicted, the second game selection screen 1100 further comprises a save icon 1135 operably connected with the save button 1105, a solve icon 1140 operably connected with the solve button 1110, a build icon 1145 operably connected with the build button 1115, an amass icon 1150 operably connected with the amass button 1120, a create icon 1155 operably connected with the create button 1125, and a restore icon 1160 operably connected with the restore button 1130. The second game selection screen 1100 further comprises the progress bar 310.

For example, while on the second game selection screen 1100, the system plays a voiceover that says to the user, “Being in one of these stories is going to help you on your journey. And by the way, there's a scientific basis for all of this. So, what would you like to do?: Save the world? Solve a mystery? Build something tangible? Amass points? Create beauty and express yourself? Restore order?” For example, the user selects the solve button 1110 because solving a mystery appeals to the user's investigative nature.

FIG. 12 is a screenshot of a summary screen 1200 in a system and method for connecting a user to an employment resource tailored to the user, using a game played on a computational device. The summary screen 1200 summarizes what the system has learned about one or more of the user's aptitudes, occupational personality, plans for the future, experience, game performance, and the like. The summary screen 1200 comprises a “what we've learned so far” legend 1210 and an occupational personality summary 1220. The occupational personality summary 1220 may be one of a number of possible occupational personality descriptions the system stores, from which the system selects in response to one or more of the user's answers, performance in the games, and other user data. As depicted, the occupational personality summary 1220 comprises the text, “You're curious and creative with great people skills. It's no wonder you're great at solving mysteries.” The summary screen 1200 further comprises a “find out more” button, which provides the user with more information about the user's aptitudes, occupational personality, plans for the future, experience, game performance, and the like. The summary screen 1200 further comprises the progress bar 310, which now indicates full progress by the user, and the back button 220.

FIG. 13 is a screenshot of a job category suggestion screen 1300 in a system and method for connecting a user to an employment resource tailored to the user, using a game played on a computational device. The job suggestion screen 1300 comprises a job suggestion legend 1310. As depicted, the job suggestion legend 1310 comprises the words, “Work you could love.” The job suggestion screen 1300 further comprises a high growth job suggestion button 1320, a emerging job suggestion button 1330, and a great match job suggestion button 1340. An emerging job comprises a job listed as one or more of an emerging job and a green job in at least one occupational database, such as, for example, the O*Net database (www.Onetonline. Org).

If the user presses the high growth job suggestion button 1320, the system presents the user with high growth jobs suited to one or more of the user's aptitudes, occupational personality, plans for the future, experience, game performance, and the like. If the user presses the emerging job suggestion button 1330, the system presents the user with a emerging job suited to one or more of the user's aptitudes, occupational personality, plans for the future, experience, game performance, and the like. If the user presses the great match job suggestion button 1340, the system presents the user with great match jobs particularly well suited to one or more of the user's aptitudes, occupational personality, plans for the future, experience, game performance, and the like. The job suggestion screen 1300 further comprises the progress bar 310, indicating full progress by the user, and the back button 220.

FIG. 14 is a screenshot of a emerging jobs screen 1400 in a system and method for connecting a user to an employment resource tailored to the user, using a game played on a computational device. If the user presses the emerging job suggestion button 1330, the system presents a recommended jobs screen 1400 comprising a emerging jobs screen 1400. The emerging jobs screen 1400 comprises a recommended job legend 1410. As depicted, the recommended job legend 1410 comprises the words, “Emerging occupations for you.” The emerging jobs screen 1400 further comprises a first emerging job link 1420 and a second emerging job link 1430. As depicted, the first emerging job link 1420 comprises the legend, “Sustainability Specialist” and a link to further information regarding this emerging job. As depicted, the second emerging job links 1430 comprises the legend, “Urban/Regional Planner” and a link to further information regarding this emerging job. The emerging jobs screen 1400 further comprises the progress bar 310, indicating full progress by the user, and the back button 220.

FIG. 15 is a screenshot of a selected job screen 1500 in a system and method for connecting a user to an employment resource tailored to the user, using a game played on a computational device. If the user presses the second emerging job link 1420 comprising the legend “Sustainability Specialist,” the system presents the selected job screen 1500. As depicted, the selected job screen 1500 comprises a sustainability specialist screen 1500. The selected job screen 1500 comprises a selected job legend 1510. As depicted, the selected job legend 1510 comprises the words, “Sustainability Specialist. These professionals manage all aspects of an organization's environmental footprint—from green building to smarter supply chain practices.” The selected job screen 1500 further comprises a “learn more” button 1520 and a “go back” button 1530. If the user selected the “learn more” button 1520, the system presents the user with more information about the sustainability specialist job. If the user selects the “go back” button 1530, the system returns the user to the previous screen, in this case the recommended jobs screen 1400. The selected job screen 1500 further comprises the progress bar 310, indicating full progress by the user, and the back button 220.

FIG. 16 is a screenshot of a selected job details screen 1600 in a system and method for connecting a user to an employment resource tailored to the user, using a game played on a computational device. If the user presses the “learn more” button 1520, the system presents the selected job details screen 1600 regarding the job selected by the user. The selected job details screen 1600 comprises a selected job title legend 1610, a selected job education legend 1620, a selected job median pay legend 1630, a selected job projected openings legend 1640, a needed skills button 1650, a “get education” button 1660, a “get credentials” button 1670, and a selected job application button 1680.

The selected job title legend 1610 comprises the title of the selected job about which the user indicated a desire to learn more by pressing the “learn more” button 1520. As depicted, the selected job title legend 1610 comprises the words, “Sustainability Specialist.” The selected job education legend 1620 comprises information regarding education required to perform the selected job. As depicted, the selected job education legend 1620 comprises the words, “Usually a 4-year degree,” which states the required education for the selected “Sustainability Specialist” job. The selected job median pay legend 1630 comprises information regarding median pay provided by the selected job. As depicted, the selected job median pay legend 1630 comprises the words, “Median Pay: $67,280,” indicating the latest information on median pay for the selected “Sustainability Specialist” job. The selected job projected openings legend 1640 comprises information regarding projected openings for the selected job. As depicted, the selected job projected openings legend 1640 comprises the words, “Projected Openings: 209,400,” indicating that it is projected that 209,400 “Sustainability Specialist” jobs will become available in the United States in a period of twelve months from the current date.

If the user presses the needed skills button 1650, the system takes the user to a screen showing skills needed to perform the selected job. If the user presses the “get education” button 1660, the system takes the user to a screen showing the user how to obtain education needed to perform the selected job. If the user presses the “get credentials” button 1670, the system takes the user to a screen showing the user how to obtain credentials needed to perform the selected job. If the user presses the selected job application button 1680, the system takes the user to a screen showing skills needed to perform the selected job. The selected job details screen 1600 further comprises the progress bar 310, indicating full progress by the user, and the back button 220.

For example, if the user selects a selected job that is not matched by one or more of the user's aptitudes, occupational personality, plans for the future, experience, game performance, and the like, the system can guide the user toward a more appropriate job using the persona of Doug. For example, the system would guide the user toward a more appropriate job if a recent high school graduate tried to apply for the “Sustainability Specialist” job by pressing the selected job application button 1680.

FIG. 17 is a screenshot of a selected job skills screen 1700 in a system and method for connecting a user to an employment resource tailored to the user, using a game played on a computational device. If the user presses the needed skills button 1650, the system presents the selected job skills screen 1700 showing skills that are related to the selected job. For example, the selected job skills screen 1700 comprises skills that are necessary for the selected job. For example, the selected job skills screen 1700 comprises skills that are relevant to the selected job. As depicted, the selected job skills screen 1700 comprises a selected job skill word cloud 1710. The selected job skills word cloud 1710 comprises one or more job skill words 1720A-1720G describing skills that are related to the selected job. A size of a font of a job skill word 1720A-1720G approximately represents its importance in relationship to the selected job. As depicted, the selected job skills word cloud 1710 comprises job skill words “regulatory” 1720A, “compliance” 1720B, “management” 1720C, “proposals” 1720D, “research” 1720E, “analysis” 1720F, and “affairs” 1720G.

FIGS. 18-31 are a series of screenshots of a system and method for connecting a user to an employment resource tailored to the user, using an assessment questionnaire on a computational device. The system sequentially presents to a user the screenshots comprised in the FIGS. 18-31. These figures demonstrate how embodiments of the invention assess one or more of employment interests and employment aptitudes of a user.

FIG. 18 is a screenshot of a first assessment question screen 1800 in a system and method for connecting a user to an employment resource tailored to the user, using an assessment questionnaire on a computational device. The first assessment question screen 1800 comprises a first assessment question 1810, a first assessment graphic 1820, a first assessment first answer button 1830, a first assessment second answer button 1840, and a first assessment third answer button 1850. As depicted, the first assessment question 1810 comprises the question, “Think you'd be good at building cabinets?” The first assessment graphic 1820 comprises a cartoon of a man building a cabinet. The first assessment first answer button 1830 comprises a “Nope!” button 1830, comprising a colloquial way that the user can answer the first assessment question 1810 negatively. The first assessment second answer button 1840 comprises an “Um . . . ” button 1840 comprising a colloquial way that the user can indicate that the user is one or more of unsure of a definite answer to the first assessment question 1810 and reluctant to provide a definite answer to the first assessment question 1810. The first assessment third answer button 1850 comprises a “You Bet!” button, comprising a colloquial way that the user can answer the first assessment question 1810 affirmatively.

FIG. 19 is a screenshot of a second assessment question screen 1900 in a system and method for connecting a user to an employment resource tailored to the user, using an assessment questionnaire on a computational device. The second assessment question screen 1900 comprises a second assessment question 1910, a second assessment graphic 1920, a second assessment first answer button 1930, a second assessment second answer button 1940, and a second assessment third answer button 1950. As depicted, the second assessment question 1910 comprises the question, “Any interest in laying tile?” The second assessment graphic 1920 comprises a cartoon of a man laying tile. The second assessment first answer button 1930 comprises a “Not so much” button 1930, comprising a colloquial way that the user can answer the second assessment question 1910 negatively. The second assessment second answer button 1940 comprises an “I don't know” button 1940 indicating that the user is one or more of unsure of a definite answer to the second assessment question 1910 and reluctant to provide a definite answer to the second assessment question 1910. The second assessment third answer button 1950 comprises an “Absolutely” button, comprising a colloquial way that the user can answer the second assessment question 1910 affirmatively.

FIG. 20 is a screenshot of a third assessment question screen 2000 in a system and method for connecting a user to an employment resource tailored to the user, using an assessment questionnaire on a computational device. The third assessment question screen 2000 comprises a third assessment question 2010, a third assessment graphic 2020, a third assessment first answer button 2030, a third assessment second answer button 2040, and a third assessment third answer button 2050. As depicted, the third assessment question 2010 comprises the question, “Does this seem interesting?” The third assessment graphic 2020 comprises a cartoon of a man holding an eyedropper over a test tube, with three other test tubes visible on the desk next to the man. The third assessment first answer button 2030 comprises a yes button 2030. The third assessment second answer button 2040 comprises an “Unsure” button 2040 indicating that the user is unsure of a definite answer to the third assessment question 2010. The third assessment third answer button 2050 comprises a “Not really” button, comprising a colloquial way that the user can answer the third assessment question 2010 negatively.

FIG. 21 is a screenshot of a fourth assessment question screen 2100 in a system and method for connecting a user to an employment resource tailored to the user, using an assessment questionnaire on a computational device. The fourth assessment question screen 2100 comprises a fourth assessment question 2110, a fourth assessment graphic 2120, a fourth assessment first answer button 2130, a fourth assessment second answer button 2140, and a fourth assessment third answer button 2150. As depicted, the fourth assessment question 2110 comprises the question, “Want to figure out how to reduce water pollution?” The fourth assessment graphic 2120 comprises a cartoon of a dog in a scuba diving suit and mask cleaning up an oil spill. The fourth assessment first answer button 2130 comprises a “Not really” button 2130, comprising a colloquial way that the user can answer the fourth assessment question 2110 negatively. The fourth assessment second answer button 2140 comprises an “I don't know” button 2140 indicating that the user is one or more of unsure of a definite answer to the fourth assessment question 2110 and reluctant to provide a definite answer to the fourth assessment question 2110. The fourth assessment third answer button 2150 comprises an “Absolutely” button, comprising a colloquial way that the user can answer the fourth assessment question 2110 affirmatively.

FIG. 22 is a screenshot of a fifth assessment question screen 2200 in a system and method for connecting a user to an employment resource tailored to the user, using an assessment questionnaire on a computational device. The fifth assessment question screen 2200 comprises a fifth assessment question 2210, a fifth assessment graphic 2220, a fifth assessment first answer button 2230, a fifth assessment second answer button 2240, and a fifth assessment third answer button 2250. As depicted, the fifth assessment question 2210 comprises the question, “Like writing?” The fifth assessment graphic 2220 comprises a cartoon of a man, possibly William Shakespeare, writing on a scroll using a feather pen with another feather pen and an ink bottle visible on a table. The fifth assessment first answer button 2230 comprises a “Not so much” button 2230, comprising a colloquial way that the user can answer the fifth assessment question 2210 negatively. The fifth assessment second answer button 2240 comprises a “Don't know” button 2240 indicating that the user is one or more of unsure of a definite answer to the fifth assessment question 2210 and reluctant to provide a definite answer to the fifth assessment question 2210. The fifth assessment third answer button 2250 comprises a “Sure do” button, comprising a colloquial way that the user can answer the fifth assessment question 2210 affirmatively.

FIG. 23 is a screenshot of a sixth assessment question screen 2300 in a system and method for connecting a user to an employment resource tailored to the user, using an assessment questionnaire on a computational device. The sixth assessment question screen 2300 comprises a sixth assessment question 2310, a sixth assessment graphic 2320, a sixth assessment first answer button 2330, a sixth assessment second answer button 2340, and a sixth assessment third answer button 2350. As depicted, the sixth assessment question 2310 comprises the question, “Like to play music?” The sixth assessment graphic 2320 comprises a cartoon of a man playing drums on a drum set. The sixth assessment first answer button 2330 comprises a “You bet” button 2330, comprising a colloquial way that the user can answer the first assessment question 2310 positively. The sixth assessment second answer button 2340 comprises a “Don't know” button 2340 indicating that the user is one or more of unsure of a definite answer to the sixth assessment question 2310 and reluctant to provide a definite answer to the sixth assessment question 2310. The sixth assessment third answer button 2350 comprises a “Nope” button, comprising a colloquial way that the user can answer the sixth assessment question 2310 negatively.

FIG. 24 is a screenshot of a seventh assessment question screen 2400 in a system and method for connecting a user to an employment resource tailored to the user, using an assessment questionnaire on a computational device. The seventh assessment question screen 2400 comprises a seventh assessment question 2410, a seventh assessment graphic 2420, a seventh assessment first answer button 2430, a seventh assessment second answer button 2440, and a seventh assessment third answer button 2450. As depicted, the seventh assessment question 2410 comprises the question, “Think you'd enjoy teaching exercise routines?” The seventh assessment graphic 2420 comprises a woman teaching exercise and three students doing the exercises she is teaching. The seventh assessment first answer button 2430 comprises a “No” button 2430. The seventh assessment second answer button 2440 comprises a “Not sure” button 2440 indicating that the user is one or more of unsure of a definite answer to the seventh assessment question 2410 and reluctant to provide a definite answer to the seventh assessment question 2410. The seventh assessment third answer button 2450 comprises a “Totally,” button, comprising a colloquial way that the user can answer the seventh assessment question 2410 affirmatively.

FIG. 25 is a screenshot of an eighth assessment question screen 2500 in a system and method for connecting a user to an employment resource tailored to the user, using an assessment questionnaire on a computational device. The eighth assessment question screen 2500 comprises a eighth assessment question 2510, a eighth assessment graphic 2520, a eighth assessment first answer button 2530, a eighth assessment second answer button 2540, and a eighth assessment third answer button 2550. As depicted, the eighth assessment question 2510 comprises the question, “Do you like to help people with their problems?” The eighth assessment graphic 2520 comprises a cartoon of a woman crying with her face in her hands and an apparently concerned man reaching a hand to her across the table. The eighth assessment first answer button 2530 comprises a “Yup” button 2530, comprising a colloquial way that the user can answer the first assessment question 2510 affirmatively. The eighth assessment second answer button 2540 comprises a “Don't know” button 2540 indicating that the user is one or more of unsure of a definite answer to the eighth assessment question 2510 and reluctant to provide a definite answer to the eighth assessment question 2510. The eighth assessment third answer button 2550 comprises a “Not really,” button, comprising a colloquial way that the user can answer the eighth assessment question 2510 negatively.

FIG. 26 is a screenshot of an attributes screen 2600 in a system and method for connecting a user to an employment resource tailored to the user, using an assessment questionnaire on a computational device. The attributes screen 2600 comprises attributes that the system has determined from the assessment (performed in FIGS. 18-25) are descriptive of the user. For example, the attributes comprise one or more of skills and abilities. The attributes screen 2600 comprises a attributes legend 2610. As depicted, the attributes legend 2610 comprises the words, “What's unique about you.” The attributes screen further comprises one or more attributes words 2620A-2620G that the system has determined from the assessment (performed in FIGS. 18-25) describe the user. As depicted, the attributes words 2620A-2620G comprises attributes words “influential” 2620A, “knowledge-seeking” 2620B, “confident” 2620C, “data-driven” 2620D, “unstructured” 2620E, and “self-motivated” 2620F. The attributes screen 2600 further comprises an optional icon 2630. As depicted, the icon 2630 comprises a dog icon 2630. The attributes screen 2600 further comprises a share button 2640, which if pressed by the user causes the system to allow the user to share one or more attributes words 2620A-2620G with one or more of a social network, another user, a prospective employer, and another entity. The attributes screen 2600 further comprises a back button 2650 allowing the user to return to the previous screen, in this case, to the eighth assessment question screen 2500. The attributes screen further comprises a forward button 2660 allowing the user to move to a next screen, in this case, to a job suggestion screen 2700.

FIG. 27 is a screenshot of the job category suggestion screen 2700 in a system and method for connecting a user to an employment resource tailored to the user, using an assessment questionnaire on a computational device. The job suggestion screen 2700 comprises a job suggestion legend 2710. As depicted, the job suggestion legend 2710 comprises the words, “Great job! Now let's explore work you could love.” The job suggestion screen 2700 further comprises an optional job suggestion icon 2720. As depicted, the job suggestion icon 2720 comprises a dog 2720. The job suggestion screen 2700 further comprises a high growth job suggestion button 2730, an emerging job suggestion button 2740, and a great match job suggestion button 2750. If the user presses the high growth job suggestion button 2730, the system presents the user with high growth jobs suited to one or more of the user's aptitudes, occupational personality, plans for the future, experience, game performance, and the like. If the user presses the emerging job suggestion button 2740, the system presents the user with an emerging job suited to one or more of the user's aptitudes, occupational personality, plans for the future, experience, game performance, and the like. The job suggestion screen 2700 further comprises the back button 2650 and the forward button 2660, the latter of which as depicted is whited out here and inoperative.

If the user presses the great match job suggestion button 2750, the system presents the user with great match jobs particularly well suited to one or more of the user's aptitudes, occupational personality, plans for the future, experience, game performance, and the like.

FIG. 28 is a screenshot of a screenshot of an emerging job screen 2800 in a system and method for connecting a user to an employment resource tailored to the user, using an assessment questionnaire on a computational device. If the user presses the emerging job suggestion button 2740, the system presents the emerging jobs screen 2800. The emerging jobs screen 2800 comprises an emerging legend 2810. As depicted, the emerging job legend 2810 comprises the words, “Emerging Jobs.” The emerging jobs screen 2800 further comprises an emerging job button 2820. As depicted, the emerging job button 2820 comprises the legend, “Training & Development Specialist.” The emerging job screen 2800 further comprises the back button 2650 and the forward button 2660, the latter of which as depicted is whited out here and inoperative.

If the user presses the emerging job button 2820, the system takes the user to an emerging job details screen 2900.

FIG. 29 is a screenshot of an emerging job details screen 2900 in a system and method for connecting a user to an employment resource tailored to the user, using an assessment questionnaire on a computational device. If the user presses the emerging job button 2920 comprising the legend “Training & Development Specialist,” the system presents the emerging job details screen 2900. As depicted, the emerging job details screen 2900 comprises a training and development specialist screen 2900. The emerging job details screen 2900 comprises an emerging job legend 2910. As depicted, the emerging job legend 2910 comprises the words, “Training & Development Specialist. Training and Development Specialists design and develop training programs that enhance and improve an individual's work performance as well as overall organizational performance.”

The emerging job details screen 2900 further comprises a “learn more” button 2920. The emerging job details screen 2900 further comprises the back button 2650 and the forward button 2660, the latter of which as depicted is whited out here and inoperative.

If the user presses the “learn more” button 2920, the system takes the user to an emerging job further details screen 3000.

FIG. 30 is a screenshot of an emerging job further details screen 3000 in a system and method for connecting a user to an employment resource tailored to the user, using an assessment questionnaire on a computational device. If the user presses the “learn more” button 3020, the system presents the emerging job further details screen 3000 regarding the job selected by the user. The emerging job further details screen 3000 comprises an emerging job title legend 3010, an emerging job education legend 3020, an emerging job median pay legend 3030, an emerging job projected openings legend 3040, a needed skills button 3050, a “find apprenticeship” button 3060, a “get training” button 3070, and a job application button 3080.

The emerging job title legend 3010 comprises the title of the emerging job about which the user indicated a desire to learn more by pressing the “learn more” button 3020. As depicted, the emerging job title legend 3010 comprises the words, “Training & Development Specialist.” The emerging job education legend 3020 comprises information regarding education required to perform the emerging job. As depicted, the emerging job education legend 3020 comprises the words, “Usually a Bachelor's degree,” which states the required education for the emerging “Training & Development Specialist” job. The emerging job median pay legend 3030 comprises information regarding median pay provided by the emerging job. As depicted, the emerging job median pay legend 3030 comprises the words, “Median Pay: $57,340,” indicating the latest information on median pay for the emerging “Training & Development Specialist” job. The emerging job projected openings legend 3040 comprises information regarding projected openings for the emerging job. As depicted, the emerging job projected openings legend 3040 comprises the words, “Projected Openings (by 2022): 77,200,” indicating that it is projected that 77,200 “Training & Development Specialist” jobs will become available in the United States by the year 2022.

The emerging job further details screen 3000 further comprises the back button 2650 and the forward button 2660, the latter of which as depicted is whited out here and inoperative.

If the user presses the needed skills button 3050, the system takes the user to an emerging job skills screen 3100.

FIG. 31 is a screenshot of an emerging job skills screen 3100 in a system and method for connecting a user to an employment resource tailored to the user, using an assessment questionnaire on a computational device. The emerging job skills screen 3100 comprises skills that are related to the emerging job. For example, the emerging job skills screen 3100 comprises skills that are necessary for the emerging job. For example, the emerging job skills screen 3100 comprises skills that are relevant to the emerging job. As depicted, the emerging job skills screen 3100 comprises an emerging job skill word legend 3120 and an emerging job skill word cloud 3120. The emerging job skill word cloud 3120 comprises one or more emerging job skill words 3130A-3130G describing skills that are related to the emerging job. A size of a font of an emerging job skill word 3130A-3130G approximately represents its importance in relationship to the emerging job. As depicted, the emerging job skill word cloud 3120 comprises emerging job skill words “storytelling” 3130A, “postproduction” 3130B, “copywriting” 3130C, “video editing” 3130D, “editing” 3130E, “video production” 3130F, and “publishing” 3130G.

The emerging job skills screen 3100 further comprises the share button 2640, the back button 2650 and the forward button 2660.

FIGS. 32-45 are a series of screenshots of a system and method for connecting a user to an employment resource tailored to the user, using a game played on a computational device. The system sequentially presents to a user the screenshots comprised in the FIGS. 32-45. These figures demonstrate how embodiments of the invention score one or more of a user's aptitudes, occupational personality, plans for the future, experience, game performance, and the like.

FIG. 32 is a screenshot of a game introductory screen 3200 in a system and method for connecting a user to an employment resource tailored to the user, using a game played on a computational device. The game introductory screen 3200 comprises a game introductory graphic 3210 and a “play games to build skills” button 3220. As depicted, the game introductory graphic comprises a cartoon depicting three humans and a dog, a coffee maker on a table, and a blackboard that reads, “Joltin' Joe's Café,” the blackboard further comprising a drawing of a baseball hitter who has just swung a bat and hit a cup of coffee.

If the user presses the “play games to build skills” button 3220, the system takes the user to a skills menu 3300.

FIG. 33 is a screenshot of a skills menu 3300 in a system and method for connecting a user to an employment resource tailored to the user, using a game played on a computational device. The skills menu 3300 comprises a skills menu legend 3310 and a skills menu list 3320. The skills menu list 3320 comprises a “teamwork & collaboration” button 3330, a “problem solving & decision making” button 3340, a communication button 3350, a conflict resolution button 3360, a consensus building button 3370, and a personal brand button 3380. The user chooses which of the buttons 3330-3380 comprised in the skills menu list 3320 pertain to a skill the user wishes to test in a game. As depicted, if the user presses the “teamwork & collaboration” button 3330, the system takes the user to a “teamwork & collaboration” first game screen 3400.

FIG. 34 is a screenshot of the first game screen 3400 in a system and method for connecting a user to an employment resource tailored to the user, using a game played on a computational device. The first game screen 3400 comprises a first rule banner 3410, a timer 3420, an optional first graphic 3430, a first rule legend 3440, and a first gameboard 3450. The first rule banner 3410 comprises the words, “Rule 1.” When the game begins, the timer 3420 counts down starting from 20 seconds. Currently the timer 3420 is showing 20 seconds. As depicted, the optional first graphic 3430 comprises a cartoon of a young black-haired woman going through the bottom drawer in a filing cabinet. The system symbolically represents the user as the black-haired woman. Prior to the beginning of the game, the system may have presented the user with choices as to how the user wished to be represented in graphics used by the system. The first rule legend 3440 comprises a legend, “Collect Numbers in Descending Order,” instructing the user as to the first rule of the game.

The first gameboard 3450 comprises a four by four grid of sixteen tiles 3460A-3460P. Currently four of the sixteen tiles, 3460A, 3460J, 3460K, and 3460O are blacked out. Of the remaining twelve tiles, ten tiles—tiles 3460C-3460I inclusive, 3460M, 3460N, and 3460P—comprise a number and the other two tiles, tiles 3460B and 3460L, have question marks on them, indicating that the numbers associated with these two tiles 3460B and 3460L are not yet known. The tiles 3460C, 3460I, and 3460P each comprise the number 10, and the tile 3460G comprises the number 9. These are the highest numbers shown on any of the tiles 3460A-3460P that are not blacked out. The tiles 3460C, 3460I, and 3460P each comprise the number 10, and the tiles 3460D and 3460E comprise the number 3. Accordingly, following the Rule 1's instruction to collect numbers in descending order, the user clicks on the tiles 3460C, 3460I, and 3460P, each comprising the number 10, and then the user clicks on the tile 3460G comprising the number 9. The system responds by whiting out each of the tiles that was clicked on, tiles 3460C, 3460G, 3460I, and 3460P, generating a second game screen 3500.

FIG. 35 is a screenshot of the second game screen 3500 in a system and method for connecting a user to an employment resource tailored to the user, using a game played on a computational device. The second game screen 3500 comprises a second gameboard 3510. The second game screen 3500 again comprises the first rule banner 3410, the timer 3420, the optional first graphic 3430, and the first rule legend 3440. Currently the timer 3420 is showing 15 seconds.

The second gameboard 3510 again comprises the four by four grid of the sixteen tiles 3460A-3460P. Currently four of the sixteen tiles, 3460A, 3460J, 3460K, and 3460O are blacked out and the four that the user clicked on, tiles 3460C, 3460G, 3460I, and 3460P, are whited out. Of the remaining eight tiles, six tiles—tiles 3460D, 3460E, 3460F, 3460H, 3460M, and 3460N—comprise a number and the other two tiles, tiles 3460B and 3460L, have question marks on them, indicating that the numbers associated with these two tiles 3460B and 3460L are not yet known. The tiles 3460F, 3460H, 3460M, and 3460N each comprise the number 7. This is the highest number shown on any of the tiles 3460A-3460P that are not blacked out and are not whited out. Accordingly, following the Rule 1's instruction to collect numbers in descending order, the user clicks on the tiles 3460F, 3460H, 3460M, and 3460N, each comprising the number 7. The system responds by whiting out each of the tiles that was clicked on, tiles 3460F, 3460H, 3460M, and 3460N, generating a third game screen 3600.

FIG. 36 is a screenshot of the third game screen 3600 in a system and method for connecting a user to an employment resource tailored to the user, using a game played on a computational device. The third game screen 3600 comprises a third gameboard 3610. The third game screen 3600 again comprises the first rule banner 3410, the timer 3420, the optional first graphic 3430, and the first rule legend 3440. Currently the timer 3420 is showing 09 seconds.

The third gameboard 3610 again comprises the four by four grid of the sixteen tiles 3460A-3460P. Currently four of the sixteen tiles, 3460A, 3460J, 3460K, and 3460O are blacked out and the eight that the user clicked on, tiles 3460C, 3460F, 3460G, 3460H, 3460I, 3460M, 3460N, and 3460P, are whited out. Of the remaining four tiles, two tiles—tiles 3460D and 3460E—comprise a number and the other two tiles, 3460B and 3460L, have question marks on them, indicating that the numbers associated with these two tiles 3460B and 3460L are not yet known. The tiles 3460D and 3460E each comprise the number 3. This is the highest number shown on any of the tiles 3460A-3460P that are not blacked out and are not whited out. Accordingly, following the Rule 1's instruction to collect numbers in descending order, the user clicks on the tiles 3460B and 3460L, each comprising the number 3. The system responds by whiting out each of the tiles that was clicked on, tiles 3460B and 3460L, generating a fourth game screen 3700.

FIG. 37 is a screenshot of the fourth game screen 3700 in a system and method for connecting a user to an employment resource tailored to the user, using a game played on a computational device. The fourth game screen 3700 comprises a fourth gameboard 3710. The fourth game screen 3700 again comprises the first rule banner 3410, the timer 3420, and the first rule legend 3440. An optional second graphic 3720 depicts the dark-haired woman walking in past the file cabinet and in an offscreen direction. Currently the timer 3420 is showing 06 seconds.

The fourth gameboard 3710 again comprises the four by four grid of the sixteen tiles 3460A-3460P. Currently four of the sixteen tiles, 3460A, 3460J, 3460K, and 3460O are blacked out and the ten that the user clicked on, tiles 3460C, 3460D, 3460E, 3460F, 3460G, 3460H, 3460I, 3460M, 3460N, and 3460P, are whited out. The remaining two tiles, tiles 3460B and 3460L, have question marks on them, indicating that the numbers associated with these two tiles 3460B and 3460L are not yet known. Accordingly, no number is currently showing on any of the tiles 3460A-3460P. Accordingly, the system responds to the user's completion of Rule 1's instruction to collect numbers in descending order, and the system responds by generating a fifth game screen 3800.

FIG. 38 is a screenshot of the fifth game screen 3800 in a system and method for connecting a user to an employment resource tailored to the user, using a game played on a computational device. The fifth game screen 3800 comprises a second rule banner 3810, a second rule legend 3820, and a fifth gameboard 3830. The second rule banner 3810 comprises the words, “Rule 2.” When the game begins, the timer 3420 counts down starting from 20 seconds. Currently the timer 3420 is showing 20 seconds. The second rule legend 3820 comprises a legend, “Collect Odd Numbers,” instructing the user as to the second rule of the game. An optional third graphic 3840 depicts the dark-haired woman sitting in a chair at a table writing on a piece of paper. The fifth game screen 3800 again comprises the timer 3420.

The fifth gameboard 3830 again comprises the four by four grid of sixteen tiles 3460A-3460P. Currently four of the sixteen tiles, 3460A, 3460J, 3460K, and 3460O are blacked out. Of the remaining twelve tiles, ten tiles—tiles 3460C-3460I inclusive, 3460M, 3460N, and 3460P—comprise a number and the other two tiles, tiles 3460B and 3460L, have question marks on them, indicating that the numbers associated with these two tiles 3460B and 3460L are not yet known. The tiles 3460C, 3460I, and 3460P each comprise the number 10, and the tile 3460G comprises the number 9. These are the highest numbers shown on any of the tiles 3460A-3460P that are not blacked out.

The system introduces a teamwork and collaboration element in response to the user's selection in FIG. 33 of the “teamwork & collaboration” button 3330. Accordingly, the system presents a sixth game screen 3900.

FIG. 39 is a screenshot of the sixth game screen 3900 in a system and method for connecting a user to an employment resource tailored to the user, using a game played on a computational device. The sixth game screen 3900 presents again the same fifth gameboard 3830 as was shown in FIG. 38. The sixth game screen 3900 again comprises the timer 3420, the second rule banner 3810, and the second rule legend 3820. Currently the timer 3420 is showing 20 seconds.

The fifth gameboard 3830 again comprises the four by four grid of sixteen tiles 3460A-3460P. The sixth game screen 3900 further comprises a first “teamwork & collaboration” graphic 3910. As depicted, the first “teamwork & collaboration” graphic 3910 comprises a cartoon of a young blond-haired woman coming up to the black-haired woman while she is sitting at the table working on the paper. The sixth game screen 3900 thereby shows content in a narrative screen, the top screen, that is designed to connect gameplay, shown in the lower screen, to teamwork skills. As depicted, the blond-haired woman asks the black-haired woman, “Do you need help?” The system thereby presents the user with an offer of help from the system. The system then presents the user with an opportunity to respond to the question as to whether the user wishes help. Accordingly, the system presents a seventh game screen 4000.

FIG. 40 is a screenshot of the seventh game screen 4000 in a system and method for connecting a user to an employment resource tailored to the user, using a game played on a computational device. The seventh game screen 4000 presents again the same fifth gameboard 3830 as was shown in FIG. 38. The seventh game screen 4000 again comprises the timer 3420, the second rule banner 3810, and the second rule legend 3820. Currently the timer 3420 is showing 20 seconds.

The fifth gameboard 3830 again comprises the four by four grid of sixteen tiles 3460A-3460P. The seventh game screen 4000 further comprises a second “teamwork & collaboration” graphic 4010. As depicted, the second “teamwork & collaboration” graphic 4010 comprises a cartoon showing two response alternatives 4020 and 4030 available to the black-haired woman to respond to the question posed in FIG. 39 by the young blond-haired woman as to whether the black-haired woman needed help. Response alternative 4020 comprises the words, “OK, great, thanks!” Response alternative 4030 comprises the words, “I have this figured out, but thanks for the offer.”

As depicted, the user decides to accept help. Accordingly, the system presents an eighth game screen 4100.

FIG. 41 is a screenshot of the eighth game screen 4100 in a system and method for connecting a user to an employment resource tailored to the user, using a game played on a computational device. The eighth game screen 4100 comprises an eighth gameboard 4110. The eighth game screen 4100 again comprises the timer 3420, the second rule banner 3810, and the second rule legend 3820. Currently the timer 3420 is showing 20 seconds.

The eighth gameboard 4110 again comprises the four by four grid of sixteen tiles 3460A-3460P. The eighth game screen 4100 further comprises a third “teamwork & collaboration” graphic 4120. As depicted, the third “teamwork & collaboration” graphic 4120 comprises a cartoon showing the blond-haired woman saying to the black-haired woman, “Here are the mystery numbers.” The system selects this third “teamwork & collaboration” graphic 4120 based on the user's selection in FIG. 40 of the response alternative 4020 comprising the words, “OK, great, thanks!” accepting the offer of help from the system. Based on the user's selection in FIG. 40 of the response alternative 4020, the system reveals the identities of the two tiles 3460B and 3460L that previously comprised question marks. The system displays a “6” inside a star in both of tiles 3460B and 3460L. Alternatively, for example, the system could be designed to reward individual work, and could provide the missing numbers based on and to reward the user's selection in FIG. 40 of the response alternative 4030, namely, “I have this figured out, but thanks for the offer.” Alternatively, for example, the system could provide a response that is not affected by the user's selection of one or more of the response alternative 4020 and 4030.

Currently four of the sixteen tiles, 3460A, 3460J, 3460K, and 3460O are blacked out. Of the remaining twelve tiles, all twelve now comprise a number. The tiles 3460B and 3460L comprise the number 6. The tiles 3460C, 3460I, and 3460P each comprise the number 10, and the tile 3460G comprises the number 9. The tiles 3460F, 3460H, 3460M, and 3460N each comprise the number 7, and the tile 3460G comprises the number 9. The tiles 3460C, 3460I, and 3460P each comprise the number 10, and the tiles 3460D and 3460E comprise the odd number 3. Accordingly, following the Rule 1's instruction to collect odd numbers in descending order, the user clicks on the tiles 3460D and 3460E, each comprising the odd number 3. The system responds by whiting out each of the tiles that was clicked on, tiles D and 3460E, generating a ninth game screen 4200.

FIG. 42 is a screenshot of the ninth game screen 4200 in a system and method for connecting a user to an employment resource tailored to the user, using a game played on a computational device. The ninth game screen 4200 comprises a ninth gameboard 4210. The ninth game screen 4200 again comprises the timer 3420, the second rule banner 3810, and the second rule legend 3820. Currently the timer 3420 is showing 18 seconds.

The ninth gameboard 4210 again comprises the four by four grid of sixteen tiles 3460A-3460P. The ninth game screen 4200 further comprises the optional third graphic 3840 previously seen in FIG. 38, depicting the dark-haired woman sitting in a chair at a table writing on a piece of paper.

The ninth gameboard 4210 again comprises the four by four grid of the sixteen tiles 3460A-3460P. Currently four of the sixteen tiles, 3460A, 3460J, 3460K, and 3460O are blacked out and the two that the user clicked on, tiles 3460D and 3460E, are whited out. The tile 3460G comprises the odd number 9. The tiles 3460F, 3460H, 3460M, and 3460N each comprise the number 7. These are the only remaining odd numbers that are not whited out. Accordingly, following the Rule 2's instruction to collect odd numbers, the user clicks on the tiles 3460F, 3460G, 3460H, 3460M, and 3460N, each comprising an odd number. The system responds by whiting out each of the tiles that was clicked on, tiles 3460F, 3460G, 3460H, 3460M, and 3460N, generating a tenth game screen 4300.

FIG. 43 is a screenshot of the tenth game screen 4300 in a system and method for connecting a user to an employment resource tailored to the user, using a game played on a computational device. The tenth game screen 4300 comprises a tenth gameboard 4310. The tenth game screen 4300 again comprises the timer 3420, the second rule banner 3810, the second rule legend 3820, and the optional third graphic 3840. Currently the timer 3420 is showing 12 seconds.

The tenth gameboard 4310 again comprises the four by four grid of sixteen tiles 3460A-3460P. Currently four of the sixteen tiles, 3460A, 3460J, 3460K, and 3460O are blacked out and the seven that the user clicked on, tiles 3460D-3460H inclusive, tile 3460M, and tile 3460N, are whited out. The tiles 3460B and 3460L comprise the even number 6. The tiles 3460C, 3460I, and 3460P comprise the even number 10. Accordingly, no odd numbers remain for the user to click on following the Rule 2's instruction to collect odd numbers. The system responds by presenting an eleventh game screen 4400.

FIG. 44 is a screenshot of the eleventh game screen 4400 in a system and method for connecting a user to an employment resource tailored to the user, using a game played on a computational device. The eleventh game screen 4400 comprises an eleventh gameboard 4410. The eleventh game screen 4400 again comprises the timer 3420, the second rule banner 3810, and the optional third graphic 3840. The eleventh game screen 4400 further comprises a third rule legend 4420. As depicted, the third rule legend 4420 comprises the words, “Now follow Rule 1.” Currently the timer 3420 is showing 09 seconds.

The eleventh gameboard 4410 again comprises the four by four grid of sixteen tiles 3460A-3460P. In response to the third rule legend 4420, the user has clicked on the highest remaining number, the tiles 3460C, 3460I, and 3460P comprising the number 10. The system responds by presenting the eleventh gameboard 4410 with the same four of the sixteen tiles, 3460A, 3460J, 3460K, and 3460O blacked out and with the eleven that the user clicked on—tiles 3460C-3460I inclusive, tile 3460M, tile 3460N, and tile 3460P—whited out. The tiles 3460B and 3460L comprise the even number 6 and are the only tiles that are not whited out and are not blacked out. The user then clicks on tiles 3460B and 3460L and accordingly, the system responds by presenting a twelfth game screen 4500.

FIG. 45 is a screenshot of the twelfth game screen 4500 in a system and method for connecting a user to an employment resource tailored to the user, using a game played on a computational device. The twelfth game screen 4500 comprises a twelfth gameboard 4510. The twelfth gameboard 4510 comprises a game score legend. As depicted, the game score legend 4520 comprises the words, “200 PTS!” indicating that the user has scored 200 points in the game. The twelfth game screen 4500 further comprises a game completion legend 4530. As depicted, the game completion legend 4530 comprises the word, “Completed!,” indicating that the user has successfully completed playing the game. The twelfth game screen 4500 again comprises the timer 3420 and the optional third graphic 3840. Currently the timer 3420 is showing 06 seconds.

The twelfth gameboard 4410 again comprises the four by four grid of sixteen tiles 3460A-3460P. At this point, all tiles have been either whited out or blacked out, and the game is completed. Optionally, the system then takes the user to a screen (not shown) to offer the user an option to do one or more of play another game, complete an assessment questionnaire, and sign off the system.

FIG. 46 is a flowchart of a method 4600 for connecting a user to an employment resource tailored to the user. The order of steps in the method 4600 is not constrained to that shown in FIG. 46 or described in the following discussion. Several of the steps could occur in different order without affecting the final result.

In step 4610, a computational device, using an assessment questionnaire, assesses a user regarding one or more of an interest, a hard skill, a soft skill, a job-specific skill, an occupational personality trait, training, education, experience, and aptitude for a job. Block 4610 then transfers control to block 4620.

In step 4620, the computational device presents the assessment to one or more of the user and a prospective employer of the user. Block 4620 then terminates this process.

FIG. 47 is a flowchart of a method 4700 for connecting a user to an employment resource tailored to the user. The order of steps in the method 4700 is not constrained to that shown in FIG. 47 or described in the following discussion. Several of the steps could occur in different order without affecting the final result.

In step 4710, a computational device presents a game to a user to play. Block 4710 then transfers control to block 4720.

In step 4720, the computational device scores the user, based on the user's play, regarding one or more of an interest, a hard skill, a soft skill, a job-specific skill, an occupational personality trait, training, education, experience, and aptitude for a job. Block 4720 then transfers control to block 4730.

In step 4730, the computational device asks a high-scoring user for permission to share the high-scoring user's score with a prospective employer of the high-scoring user. Block 4730 then transfers control to block 4740.

In step 4740, the computational device presents the user's score to the prospective employer of the user. Block 4730 then terminates this process.

According to other embodiments of the invention, the system and method connects an employer user to one or more of an employer assessment, training, and one or more new hire suggestions. For example, the system and method provides the new hire suggestions at no cost to the employer user during a trial period. For example, the system and method charges the employer one or more of a subscription fee, a fee for posting a job opening, a fee for receiving a new hire suggestion, and another fee. The employer user may have the opportunity to receive new hire suggestions. For example, a new hire suggestion may comprise a suggestion that an existing employee be transferred to a new position.

According to further embodiments of the invention, the employment resources are tailored to one or more of the user and the employer using one or more tailoring techniques comprising one or more of an algorithm, gamification, online training, mobile technology and a feedback loop. For example, the algorithm connects one or more users to one or more of jobs and fields with high potential for the user's success. For example, the algorithm analyzes one or more of a user's game performance, a user's aptitudes, and a user's occupational personality test results, and uses the analysis to recommend one or more jobs in which the user is likely to succeed.

For example, the algorithm connects employers with users having a maximal high probability of success. For example, the algorithm scores passive users' likelihood of switching careers or jobs. For example, the algorithm matches success profiles to one or most of the right employer, the right job, training opportunities, and education opportunities. For example, feedback loops comprise one or more of pattern recognition to improve predictive capabilities, matching techniques, and scoring techniques. For example, the one or more tailoring techniques increase the probability of success of the career opportunity.

According to further embodiments of the invention, a user comprises one or more of a user and an employer. According to yet other embodiments of the invention, a user uploads a profile and registers on the system. For example, a game measures one or more characteristics of the user selected from an ability, a work activity, a soft skill, a hard skill, and knowledge. For example, soft skills comprise one or more of communication effectiveness, enthusiasm, attitude, teamwork, networking ability, problem solving ability, critical thinking ability, analytic reasoning ability, work ability under pressure, decision making ability, professionalism, work ethic, dependability, self-motivation, team-orientation, organization, flexibility, confidence, and another soft skill.

Embodiments of the invention gamify the matching of users and employers using a mobile game to score a user's potential. For example, matching is carried out using one or more of game data, assessment questionnaire answers, a curriculum vitae, user interests, user experience, and user plans for the future.

For example, based on one or more of a profile completed by the user, assessment questionnaire answers, and the soft skills measured by the game, the system provides to the user one or more of customized pathways, job recommendations, new hire recommendations, a link to lifestyle information, a link to education, a link to training, a link to financial aid, a link to an internship, a link to a mentorship, employer information, new hire information, a job opening, and a job application portal. The application portal allows the user to do one or more of apply for the selected job, view an aggregated job posting by an employer that is not currently a user of the system, view a direct job posting by an employer users, view a link to a website of an employer user.

For example, an employer may pay for membership under a subscription model. For example, the subscription may cover subscription benefits comprising one or more of an employer database, access to user profiles, the ability to contact users, the ability to make postings of job openings, and other subscription benefits.

For example, a fixed job posting fee may be charged to an employer who does not have a subscription. For example, fixed job posting fees may be payable by a smaller employer who does not have a subscription. For example, fixed job posting fees may be unavailable to larger employees. For example, larger employees may be required to purchase a subscription in order to post available job openings. For example, a subscription may cost approximately $12,000 to approximately $35,000 annually. For example, a small employer may be defined as an employer with fewer than approximately 10,000 employees. For example, a large employer may be defined as an employer with more than approximately 10,000 employees. For example, a small employer may be defined as an employer with fewer than approximately 100 employees. For example, a large employer may be defined as an employer with more than approximately 100 employees. For example, a small employer may be defined as an employer with annual profits of less than approximately $5,000,000. For example, a large employer may be defined as an employer with annual profits of more than approximately $5,000,000.

For example, employment resources may comprise access to one or more templates. For example, employment resources may comprise access to one or more job posting templates. For example, employment resources may comprise access to one or more job application templates. For example, in the case where the user is an employer, users scoring above an employer-designated cutoff score on one or more employer-designated employment criteria are pushed to the employer.

For example, an employer user may be permitted under a standard employer membership to search any profile of an employee user. For example, an employer user may be permitted under a standard employer membership to search a fixed number of profiles of employee users per month. For example, an employer user may be permitted under a standard employer membership to search a fixed number of profiles of employee users per day. For example, an employer user may be permitted under a standard employer membership to post a fixed number of job postings per month. For example, an employer user may be permitted under a standard employer membership to post a fixed number of job postings per day. For example, an employer user may be permitted under a standard employer membership to post fifty job postings per month. For example, an employer user may receive one or more passive users recommended by the system for one or more job postings previously posted by the employer user.

For example, different categories of membership may be available to employer users. For example, relative to a standard employer membership, a founding partner membership may allow an employer user to search a greater number of profiles of employee users per month. For example, a founding partner membership may allow an employer user to search a greater number of profiles of employee users per day. For example, a founding partner membership may allow an employer user to search an unlimited number of profiles of employee users. For example, an employer user may be permitted to post a greater number of job postings per month. For example, an employer user may be permitted to post a greater number of job postings per day. For example, an employer user may be permitted to post an unlimited number of job postings.

According to embodiments of the invention, the cost of a founding partner membership may be customized based on the employer user's characteristics. For example, founding partner users may be permitted to post an unlimited number of job postings. For example, relative to standard employer users, premier employer users may be permitted to post a greater number of job postings. For example, founding partner users may be permitted to post an unlimited number of job postings. For example, premier employer users may be permitted to send an unlimited number of messages to other users. For example, founding partner users may be permitted to receive an unlimited number of messages from other users.

For example, founding partner users may be permitted to post audiovisual media in their profile. The audiovisual media may comprise one or more of a photograph, a video, and another audiovisual media. The audiovisual media may comprise one or more of an advertisement, a training, a presentation of a particular job opening, a presentation of working conditions at the employer, and another audiovisual media. For example, founding partner users may be granted access to one or more of a user search tool, an interface with a recruitment resource, a user referral, an ATS, a user database, and a portal to a completed job application. For example, the user search tool may be a Boolean user search tool. For example, the recruitment resource may comprise recruiting technology. For example, the recruitment resource may comprise an interface with a human recruiter.

For example, different categories of membership may be available to employee users. For example, relative to a standard employee membership, a premiere employee membership may allow an employee user to search a greater number of job postings per month. For example, a premiere employee membership may allow an employee user to search a greater number of job postings per day. For example, a premiere employee membership may allow an employee user to search an unlimited number of job postings. For example, an employee user may be permitted to post a greater number of job applications per month. For example, an employer user may be permitted to post a greater number of job applications per day. For example, an employer user may be permitted to post an unlimited number of job applications.

For example, relative to standard employee users, premiere employee users may be permitted to post a greater number of job applications. For example, premiere employee users may be permitted to post an unlimited number of job applications. For example, premiere employee users may be permitted to send an unlimited number of messages to other users. For example, premiere employee users may be permitted to receive an unlimited number of messages from other users.

For example, premiere employee users may be permitted to post audiovisual media in their profile. The audiovisual media may comprise one or more of a photograph, a video, and another audiovisual media. The audiovisual media may comprise a video presentation of an employee user's qualifications. For example, premiere employee users may be granted access to one or more of a job search tool, an interface with a recruitment resource, a job referral, a portal to a job application template, and a portal to a job application. For example, the job search tool may be a Boolean job search tool. For example, the recruitment resource may comprise recruiting technology. For example, the recruitment resource may comprise an interface with a human recruiter.

According to other embodiments of the invention, employee users can be provided with a skills translator. For example, the skills translator can be available to one or more of veterans and employee users transitioning between jobs.

According to still further embodiments of the invention, an employee user can generate a user success profile for himself or herself comprising one or more of a recommended field, a recommended job opening, a projection of job evolution in a given field, an education requirement, a training requirement, a detailed job posting, a portal to a training opportunity, a user potential metric, a user loyalty metric, a user corporate fit metric, and a portal to a job application.

According to yet other embodiments of the invention, an employer user can generate one or more user assessments that assess the suitability of a user for one or more of a particular job opening and general suitability to work for the employer user. A user assessment comprises assessments of one or more of a soft skill, a hard skill, experience, education, training information, certification information, a skills translator, a occupational personality assessment, a psychometric screening, a mathematical test, a problem solving test, a literacy test, a reasoning test, a spatial reasoning test, a multiple choice test, another test, and another user assessment questionnaire. For example, a soft skill may be assessed by use of a questionnaire. For example, a soft skill may be assessed by use of a questionnaire comprising a hypothetical scenario. For example, the occupational personality assessment may comprise a tool configured to scrape relevant social media. For example, the occupational personality assessment may comprise a tool configured to scrape relevant social media for an assessment of one or more of a occupational personality type, a occupational personality fit, and user interests.

According to still further embodiments of the invention, recent workforce entrants may be provided with tailored tools comprising one or more of a database of training opportunities, access to screening tests, access to job opportunities, and a Short Message Service (SMS) job alert.

Following are three examples of users according to embodiments of the invention.

Sample user. Anna Kearns. High school senior. Everyone tells Anna she needs to go to a four-year college. She's constantly told computer programming or health care would be great choices. The disconnect: Anna's only work experience is in retail and she isn't sure what she wants to do. She'd like to know about all options and get an idea of what she'd be good at. Anna's User Success Profile aligns her interest in travel and aptitude for working with people. She's given a pathway of hospitality industry jobs, from entry-level positions to high-level management positions. She's given information about anticipated growth, pay and the time that training/education should take. She also receives a “Want another option?” prompt for other opportunities.

Sample user. Navy Petty Officer Santos. Pay grade: E-4. Occupation: JO-16. Skills include letter writing, data entry and typing. Suggested civilian jobs include retail assistant manager, billing rep, cashier and pet trainer. The disconnect: JO-16 is a public relations role responsible for managing ad buys, writing feature articles, producing broadcast segments and coordinating events. Santos' User Success Profile reveals career recommendations that are aligned with his interests, aptitudes, and skills. Instead of pet trainer, the tool suggests Santos consider a career as a social media manager. He is given insight into the required training, pay, lifestyle, and anticipated job growth. Since he's ready to go, Santos gets access to jobs immediately.

Sample employer user. Corporate partner: a global online retailer. Employees: 120,000. Immediate need: Full staffing for a new 300-employee call center. Past approach: Outsource recruitment of non-exempt employees to a staffing firm; in-house handling of assessment, interview, training, onboarding. The employer user completes a corporate culture assessment and job needs profile including available roles, requirements, compensation, etc. The platform is integrated into the corporate ATS. Passive and active users for exempt and technical positions are pushed to the employer user. Users for entry-level and hourly positions are screened by the technology and receive a text alert and can apply via a mobile application or online.

Benefits provided by embodiments of the invention include rendering more enjoyable one or more of the search for a job, the search for training opportunities, the search for education opportunities, and the search for a new hire. Connections with one or more of users and career opportunities are based on aptitude, interest, psychometrics and right-fit, not just skills and experience keywords. Applications are reduced to those people likely to succeed in a particular role and within a particular corporate culture. People will connect to jobs in which they will be the most productive and with which they will be the most satisfied. In addition to game data, the user profile will generate experience keywords. The system analyzes the data from the game, assessments and user profile and recommends specific job matches in high-growth industries. The system matches young people to high-growth jobs and career paths. The technology also classifies users as “ready to go” or “ready to train” based on user-uploaded profile data.

Embodiments of the invention combine self-assessment, social media scraping, psychometrics, skills tests, experience and Boolean search to yield a user success profile. Other embodiments of the invention comprise smart technology configured to probe core attributes linked to high potential for success. Further embodiments of the invention comprise technology configured to screen for traits and attributes that contribute to success for one or more of an employer and an employee. Additional embodiments of the invention connect users to employment resources based on one or more of stated user interests, a user assessment and industry developments. Still other embodiments of the invention integrate resources configured to perform one or more of posting one or more of an available position and a job application, tracking one or more job applicants, screening one or more job applicants, training one or more job applicants, and recruiting one or more job applicants. Further embodiments of the invention provide employers with an integrated system for one or more of talent development, talent acquisition, recruitment, user assessment, user screening, job applications, and training.

For example, it will be understood by those skilled in the art that software used by the system and method for connecting a user, an employer, and an employment resource be located in any location in which it may be accessed by the system. For example, it is well within the scope of embodiments of the invention that one or more of the employment questionnaire and the game be located in another location rather than being comprised in the computational device. It will be further understood by those of skill in the art that the number of variations of the network, location of the software, and the like are virtually limitless. It is intended, therefore, that the subject matter in the above description shall be interpreted as illustrative and shall not be interpreted in a limiting sense.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention. For example, certain privileges that are mentioned as potentially being limited to premiere employee users can instead be provided to regular users for an additional fee. For example, certain privileges that are mentioned as potentially being limited to premiere employee users can instead be provided to regular users for free. For example, certain privileges that are mentioned as potentially being limited to premiere employee users can also be provided to regular users, but with a smaller maximum number of uses of this benefit in a given time period. For example, premiere employee users may be entitled to an unlimited number of messages while regular employee members are only entitled to send or receive thirty messages per month.

For example, the order of the screens and pages presented to the user in one or more of the assessment questionnaire and the game could be altered without substantially affecting the functioning of embodiments of the invention. Additional screens and pages could be added and screens could be removed, also without substantially affecting the functioning of embodiments of the invention. Buttons, links, legends, and other content on specific screens and on specific pages could be altered, removed, or added, also without substantially affecting the functioning of embodiments of the invention.

For example, embodiments of the invention could operate on a wide range of devices other than mobile phones, tablets, and computers without substantially affecting the functioning of embodiments of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A system for connecting a user to an employment resource tailored to the user, comprising:
a computational device configured to assess the user, using an assessment questionnaire, regarding one or more of an interest, a hard skill, a soft skill, a job-specific skill, an occupational personality trait, training, education, experience, and aptitude for a job.

2. The system of claim 1, wherein the computational device comprises a computer.

3. The system of claim 1, wherein the computational device comprises one or more of a mobile telephone and a tablet.

4. The system of claim 3, wherein the mobile telephone uses mobile virtual reality.

5. The system of claim 1, wherein the computational device comprises an online resource.

6. The system of claim 1, wherein the assessment questionnaire is animated.

7. The system of claim 1, wherein the assessment questionnaire comprises a series of assessment questions that the user answers.

8. The system of claim 1, wherein the job comprises one or more of a high growth job, a best match job best matching the user's occupational personality summary, and an emerging job.

9. The system of claim 8, wherein the high growth job comprises a job with 75,000 or more anticipated openings in the United States within the next six years.

10. The system of claim 9, wherein the high growth job comprises one or more of aerospace, advanced manufacturing, automotive, biotechnology, construction, energy, financial services, geospatial, health care, leisure and hospitality, information technology, retail, and transportation.

11. The system of claim 8, wherein the best match job comprises a job whose three-letter Holland Code matches a three-letter Holland code of the user.

12. The system of claim 8, wherein the emerging job is listed as one or more of an emerging job and a green job in at least one occupational database.

13. The system of claim 12, wherein the occupational database comprises O*Net.

14. The system of claim 1, wherein the computational device presents an assessment of the user.

15. The system of claim 1, wherein the computational device presents a user assessment to one or more of the user and a prospective employer of the user.

16. The system of claim 15, wherein the computational device presents one or more of the job-specific skills to the user.

17. The system of claim 16, wherein the computational device presents the one or more job-specific skills as a word cloud comprising the one or more job-specific skills.

18. The system of claim 17, wherein the size of a font used to present the job-specific skill represents the importance of that skill.

19. The system of claim 15, wherein the computational device ranks at least two users for their prospective appropriateness to the prospective employer.

20. A system for connecting a user to an employment resource tailored to the user, comprising:
a computational device configured to present a game to the user to play, the computational device configured to score the user based on the user's play, regarding one or more of an interest, a hard skill, a soft skill, a job-specific skill, an occupational personality trait, training, education, experience, and aptitude for a job, the computational device further configured to ask a high-scoring user for permission to share the high-scoring user's score with a prospective employer of the high-scoring user, the computational device further configured to present the assessment to the prospective employer.

21. The system of claim 20, wherein the system offers the user a choice between two or more of playing the game alone, using assisted navigation to play the game while being guided by the system, and another game playing option.

22. The system of claim 20, wherein the system presents the user with a plurality of reward systems that the user will employ while playing the game.

23. The system of claim 22, wherein the user selects a desired reward system.

24. The system of claim 23, wherein once a game is completed, the system presents the remaining reward systems again.

25. The system of claim 23, wherein once a game is completed, the process terminates without the system presenting the remaining reward systems.

26. The system of claim 20, wherein the system presents choices to the user in the context of a narrative story,

27. The system of claim 26, wherein the system presents an animated story having a plurality of branches.

28. The system of claim 27, wherein the branches comprise one or more of an option to work without assistance and an option to work with assistance.

29. The system of claim 26, wherein the user's choices drive the system's presentation of game actions.

30. The system of claim 29, wherein the user's choices affect one or more of the animated story, a gameboard that is revealed, and points that can be scored.

31. A method for connecting a user to an employment resource tailored to the user, comprising:
assessing, by a computational device, using an assessment questionnaire, the user regarding one or more of an interest, a hard skill, a soft skill, a job-specific skill, an occupational personality trait, training, education, experience, and aptitude for a job; and
presenting, by the computational device, the assessment to one or more of the user and a prospective employer of the user.

32. The method of claim 31, wherein the step of assessing comprises sub-steps of:
presenting to the user, by the computational device, a series of assessment questions;
receiving answers to the assessment questions, by the computational device, from the user; and
processing the answers, by the computational device, to obtain information regarding the one or more of an interest, a hard skill, a soft skill, a job-specific skill, an occupational personality trait, training, education, experience, and aptitude for a job.

33. A method for connecting a user to an employment resource tailored to the user, comprising:
using a computational device configured to present a game to the user to play, presenting a game to a user to play;
scoring the user, by the computational device, based on the user's play, regarding one or more of an interest, a hard skill, a soft skill, a job-specific skill, an occupational personality trait, training, education, experience, and aptitude for a job;
asking a high-scoring user, by the computational device, for permission to share the high-scoring user's score with a prospective employer of the high-scoring user; and
presenting, by the computational device, the score to one or more of the high-scoring user and the prospective employer.

34. The method of claim 33, wherein the step of presenting comprises a sub-step of offering the user a choice between two or more of playing the game alone, using assisted navigation to play the game while being guided by the system, and another game playing option.

35. The system of claim 33, wherein the step of presenting comprises offering the user a plurality of reward systems from which the user can select one to employ while playing the game.

36. The method of claim 34, wherein the sub-step of offering comprises presenting remaining reward systems once a game is finished using the selected reward system.
